(19) United States
(12) Patent Application Publication
(10) Pub. No.: US 2006/0153979 A1
(43) Pub. Date: Jul. 13, 2006

(54) Anti-glare and anti-reflection film, polarizing plate using the anti-glare and anti-reflection film, and liquid crystal display device using the polarizing plate

(75) Inventors: Tetsuya Asakura, Minami-Ashigara-shi (JP); Kazuhiro Nakamura, Minami-Ashigara-shi (JP); Shuntaro Ibuki, Minami-Ashigara-shi (JP)

Correspondence Address: BUCHANAN INGERSOLL PC;(INCLUDING BURNS, DOANE, SWECKER & MATHIS), POST OFFICE BOX 1404, ALEXANDRIA, VA, 22313-1404, US

(73) Assignee: FUJI PHOTO FILM CO., LTD., Minami-Ashigara-shi (JP)

(21) Appl. No.: 11/287,233

(22) Filed: Nov. 28, 2005

(30) Foreign Application Priority Data
Nov. 30, 2004 (JP) 2004-347053
Jul. 1, 2005 (JP) 2005-193963

(51) Int. Cl. B32B 5/16; B32B 27/30; B05D 3/12; B05D 5/06; G11B 5/64

(52) U.S. Cl. 427/164; 428/141; 428/323; 428/522; 428/421; 428/447; 428/331; 428/143; 427/355

(57) ABSTRACT

An anti-glare and anti-reflection film comprising: a transparent support; an anti-glare layer; and a low refractive index layer, wherein a value of haze which is caused due to internal scattering of the anti-glare and anti-reflection film is 0 to 35%, and a center line average roughness Ra of the anti-reflection film is 0.08 to 0.30 μm.

### BACKGROUND OF THE INVENTION

1. Field of the Invention

The present invention relates to an anti-glare and anti-reflection film, a polarizing plate, and an image display device, and more specifically, to an anti-glare and anti-reflection film including an anti-glare layer which has low internal scattering, and a low refractive index layer, a polarizing plate using the anti-glare and anti-reflection film as a surface protection film, and an image display device using the polarizing plate.

2. Description of the Related Art

Anti-glare films can be roughly divided into those having substantially only a surface scattering property and those having both the surface scattering property and an internal scattering property. In a display device, such as a CRT, a plasma display (PDP), an electroluminescence display (ELD), or a liquid crystal display device (LCD), an anti-glare film is typically disposed on an outermost surface of the display in order to prevent image reflection due to reflection of external light. In recent years, particularly, with the advancement of higher-definition display devices, techniques related to anti-glare films having, in addition to the surface scattering property, an internal scattering property higher than conventional ones have been disclosed as means for providing improvements against fine unevenness in brightness (referred to as “glaring”) due to the anti-glare films (JP-A-2000-304648, Japanese Patent No. 3507719, Japanese Patent No. 3515401, and Japanese Patent No. 3515426).

On the other hand, there is disclosed a technique related to a scattering film having no surface scattering property, but only an internal scattering property to improve viewing angle characteristics of an LCD (Japanese Patent No. 3507719). Also, as disclosed in, for example, JP-A-2003-121606 and JP-A-2003-270409, it is known that, in the case of using a light scattering film as an outermost surface of a display device, it is preferable for the film to have an anti-reflection function having the effect of suppressing surface reflection of external light in a bright room.

Recent years have seen a rapid expansion of the market for applications, such as display devices with a large screen (e.g., representatively, a liquid crystal television, etc.), which are viewed at a relatively distant position. In such applications, the size of a pixel at the same definition level is increased and a viewing distance is also increased, thereby reducing the above-mentioned glaring problem. On the other hand, the applications employ an anti-glare film with a high internal scattering property, which is widely used as means for providing improvements against the above-mentioned glaring, but the film are not necessarily optimal for the applications, because the high internal scattering property causes a reduction in image resolution (referred to as “image blurring”).

As is apparent from the foregoing, there is currently no proposed anti-glare and anti-reflection film which simultaneously achieves an anti-glare function and improvements against image blurring and glaring.

### SUMMARY OF THE INVENTION

Therefore, an object of the present invention is to provide an anti-glare and anti-reflection film which realizes both a high anti-glare function and improvements against image blurring and glaring.

Also, another object of the present invention is to provide the anti-glare and anti-reflection film with high productivity.

[Means for Solving the Problems]

The present inventors conducted intensive studies for solving the above-described problems to find that a structure described below solves the problems and achieves the above objects, thereby completing the present invention.

Specifically, the present invention achieves the above objects with the following structure.

1. An anti-glare and anti-reflection film comprising at least an anti-glare layer and a low refractive index layer which are provided on a transparent support, wherein a value of haze which is caused due to internal scattering of the anti-glare and anti-reflection film is 0 to 35%, and a center line average roughness Ra of the anti-glare and anti-reflection film is 0.08 to 0.30 μm.

2. The anti-glare and anti-reflection film as described in 1 above, wherein the value of haze which is caused due to internal scattering of the anti-glare and anti-reflection film is 0 to 10%.

3. The anti-glare and anti-reflection film as described in 1 or 2 above, wherein the value of haze which is caused due to surface scattering of the anti-glare and anti-reflection film is 5 to 15%.

4. The anti-glare and anti-reflection film as described in 3 above, wherein the value of haze which is caused due to internal scattering of the anti-glare and anti-reflection film is 0 to 5%, and the value of haze which is caused due to surface scattering of the anti-glare and anti-reflection film is 5 to 10%.

5. The anti-glare and anti-reflection film as described in any of 1 to 4 above, wherein the anti-glare layer comprises at least one type of translucent microparticle having an average particle size of 0.5 to 10 μm and a translucent resin, the translucent microparticle being are dispersed in the translucent resin, the absolute value of a difference in refractive index between the translucent microparticle and the translucent resin is 0.00 to 0.03, the translucent microparticle is contained in an amount of 3 to 30% by mass of a total solid content of the anti-glare layer, and the low refractive index layer is formed by applying a coating composition and has a refractive index of 1.30 to 1.55.

6. The anti-glare and anti-reflection film as described in 5 above, wherein the translucent resin is a polymer obtained from mainly a tri- or higher functional ionizing radiation curable compound.

7. The anti-glare and anti-reflection film as described in 6 above, wherein the tri- or higher functional ionizing radiation curable compound is mainly composed of a tri- or higher functional (meth)acrylate monomer, and the translucent microparticle is a crosslinkable poly(meth)acrylate polymer whose acryl content is 50 to 100% by mass.

8. The anti-glare and anti-reflection film as described in 6 above, wherein the tri- or higher functional ionizing radiation curable compound is mainly composed of a tri- or higher functional (meth)acrylate monomer, and the translucent microparticle is a crosslinkable poly(styrene-acryl) copolymer whose acryl content is 50 to 100% by mass.

9. The anti-glare and anti-reflection film as described in 5 above, wherein the low refractive index layer is formed by applying a curable composition mainly composed of a fluorinated polymer containing fluorine atoms in an amount of 35 to 80% by mass and a crosslinkable or polymerizable functional group.

10. The anti-glare and anti-reflection film as described in 9 above, wherein the low refractive index layer is a cured film formed by applying and curing a curable composition containing at least one type of each of the following: (A) a fluorinated polymer; (B) an inorganic microparticle whose average particle size is 30% to 100% of the thickness of the low refractive index layer; and (C) at least either a hydrolysate of organosilane or a partial condensate thereof, the organosilane being produced in the presence of an acid catalyst and represented by formula (1):
(R¹⁰)ₘSi(X)₄₋ₘ (1)
(where R¹⁰ denotes a substituted or unsubstituted alkyl group or a substituted or unsubstituted aryl group, X denotes a hydroxy group or a hydrolysable group, and m denotes an integer from 1 to 3).

11. The anti-glare and anti-reflection film as described in 10 above, wherein both the anti-glare layer and the low refractive index layer are a cured film formed by applying and curing a curable coating composition at least containing either the hydrolysate of organosilane represented by the general formula (1) or the partial condensate thereof

12. The antiglare, antireflection film set forth in the aforementioned 10, wherein said at least one of the hydrolysate of organosilane represented by the formula (1) and the partial condensate thereof is represented by formula (2): 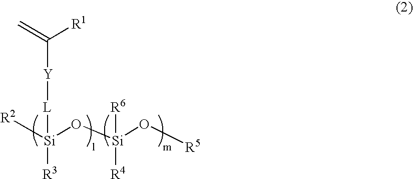
wherein, R¹ represents a hydrogen atom, methyl group, methoxy group, alkoxycarbonyl group, cyano group, fluorine atom or chlorine atom;

Y represents a single bond, *—COO—**, *—CONH—** or *—O—**;

L represents a di-valent connecting chain;

R² to R⁴ each independently represents a halogen atom, a hydroxy group, an unsubstituted alkoxy group or an unsubstituted alkyl group;

R⁵ represents a hydrogen atom or an unsubstituted alkyl group;

R⁶ represents a substituted or unsubstituted alkyl group or a substituted or unsubstituted aryl group; and

1 represents a molar fraction satisfying the numerical formula 1=100−m, wherein m represents a molar fraction of from 0 to 50.

13. The anti-glare and anti-reflection film as described in 10 above, wherein the inorganic microparticle mainly comprises oxide silicon having a hollow structure and a refractive index of 1.17 to 1.40.

14. A polarizing plate comprising a polarizing film and two protection films bonded thereto, the protection films protecting both front and back surfaces of the polarizing film, wherein the anti-reflection film as described in any of 1 to 13 above is used as one of the protection films.

15. The polarizing plate as described in 14 above, wherein one of the two protection films for forming the polarizing plate which is not used as the anti-glare and anti-reflection film is an optical compensation film having an optical compensation layer including an optically anisotropic layer on a surface opposite to a surface which is bonded to the polarizing film, the optically anisotropic layer comprises a compound having a discotic structural unit with a disk surface inclined with respect to the surface of the protection film at an angle which varies in a depth direction of the optically anisotropic layer.

16. A liquid crystal display device comprising at least one polarizing plate as described in 14 or 15 above.

17. The liquid crystal display device as described in 16 above, wherein a diagonal of a display screen is 20 inches or more.

18. A method for producing the anti-glare and anti-reflection film as described in any of 1 to 13 above, comprising positioning a land of a tip lip of a slot die close to a surface of a continuously moving web of a transparent support which is supported by a backup roll; and applying, from a slot of the tip lip, at least one of a coating composition for the anti-glare layer and a coating composition for the low refractive index layer on the transparent support, the coating composition for the anti-glare layer comprising a translucent microparticle, a translucent resin and a solvent, so as to provide at least one of the anti-glare layer and the low refractive index layer on the transparent support.

### BRIEF DESCRIPTION OF THE DRAWINGS

FIG. 1 is a cross-sectional view schematically illustrating an anti-glare film with an anti-glare property according to a preferable embodiment of the present invention (layer composition of the anti-reflection film);

FIG. 2 is a cross-sectional view of a coater 10 using a slot die 13 according to the present invention;

FIG. 3A illustrates a cross-sectional shape of the slot die 13 of the present invention;

FIG. 3B illustrates a cross-sectional shape of a conventional slot die 30;

FIG. 4 is a perspective view illustrating the slot die 13 according to the present invention and its peripheral portion during the step of coating;

FIG. 5 is a cross-sectional view illustrating a decompression chamber 40 positioned close to a web W (a back plate 40a is integrally formed with the chamber 40); and

FIG. 6 is the same as above (the back plate 40a is attached to the chamber 40 by a screw 40c).

1 denotes an anti-glare and anti-reflection film; 2 denotes a transparent support; 3 denotes an anti-glare layer; 4 denotes a low refractive index layer; 5 denotes a translucent microparticles; 10 denotes a coater; 11 denotes a backup roll; W denotes a web; 13 denotes a slot die; 14 denotes a coating liquid; 14a denotes a bead; 14b denotes a coating; 15 denotes a pocket; 16 denotes a slot; 17 denotes a tip lip; 18 denotes a land; 18a denotes an upstream-side lip land; 18b denotes a downstream-side lip land; I_{UP} denotes a land length of an upstream-side lip land 18a; I_{LO} denotes a land length of an downstream-side lip land 18b; LO denotes an overbite length (the difference in distance from a web W to a downstream-side lip land 18b and an upstream-side lip land 18a); G_{L} denotes a gap between a tip lip 17 and a web W (gap between a downstream-side lip land 18b and a web W); 30 denotes a conventional slot die; 31a denotes an upstream-side lip land; 31b denotes a downstream-side lip land; 32 denotes a pocket; 33 denotes a slot; 40 denotes a decompression chamber; 40a denotes a back plate; 40b denotes a side plate; 40c denotes a screw; G_{B} denotes a gap between a back plate 40a and a web W; and Gₛ denotes a gap between a side plate 40b and a web W.

### DETAILED DESCRIPTION OF THE INVENTION

Hereinafter, the present invention will be described in more detail. Note that in the present specification, when numerical values represent physical properties, characteristic values, or the like, the description “(numeral value 1) to (numeral value 2)” means “from (numeral value 1) or more to (numeral value 2) or less”. Also, in the present specification, the description “(meth)acrylate” means “at least either acrylate or methacrylate”. The same is applied to “(meth)acrylic acid” and the like.

A basic structure of an anti-glare and anti-reflection film according to a preferable embodiment of the present invention will be described with reference to the drawings.

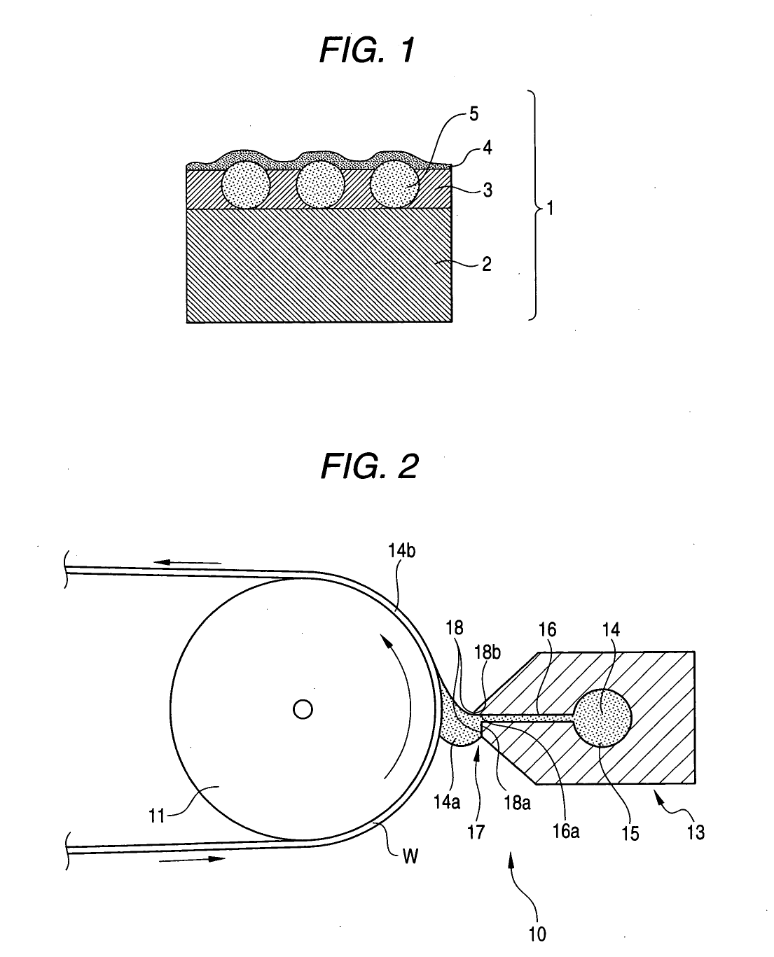

Here, FIG. 1 is a cross-sectional view schematically illustrating an anti-glare and anti-reflection film with an anti-glare property according to a preferable embodiment of the present invention.

An anti-glare and anti-reflection film 1 according to the present embodiment illustrated in FIG. 1 includes a transparent support 2, an anti-glare layer 3 formed on the transparent support 2, and a low refractive index layer 4 formed on the anti-glare layer 3. The low refractive index layer 4 is formed on the anti-glare layer 3 to a thickness of about a quarter of the wavelength of light, thereby making it possible to reduce surface reflection on the principle of thin-film interference.

The anti-glare layer 3 includes a translucent resin and a translucent microparticle 5 dispersed in the translucent resin.

The refractive indices of the layers constituting the anti-glare and anti-reflection film having an anti-reflection layer according to the present invention preferably satisfy the following relationship:

the refractive index of the anti-glare layer>the refractive index of the transparent support>the refractive index of the low refractive index layer.

In the present invention, the anti-glare layer having an anti-glare property preferably has both the anti-glare property and the hard coat property, and may be composed of a plurality of layers, e.g., two to four layers, though the one exemplified in the present embodiment is formed by a single layer. Also, the anti-glare layer may be provided on another layer above the transparent support, e.g., on an antistatic layer, an anti-moisture layer, or the like, though in the present embodiment, the anti-glare layer is directly provided on the transparent support.

Because a satisfactory anti-glare property and visually uniform matte finish are achieved, the anti-glare and anti-reflection film of the present invention is preferably designed to have a rough surface shape such that the center line average roughness Ra is 0.08 to 0.30 μm. Further, the ten-point height of irregularities Rz is preferably ten times or less than Ra, the average peak-to-trough distance Sm is 1 to 100 μm, the standard deviation of the height of a convex portion from the deepest portion of convex and concave portions is 0.5 μm or less, the standard deviation of the average peak-to-trough distance Sm with reference to the center line is 20 μm or less, and surface portions having an angle of inclination from 0 to 5 degrees accounts for 10% or more of the entire surface, because more satisfactory anti-glare property and visually uniform matte finish are achieved. When Ra falls below 0.08, a satisfactory anti-glare property cannot be achieved, and when Ra exceeds 0.30, problems such as glaring and surface clouding due to reflection of external light occurs. Ra is preferably 0.09 to 0.28 μm, is more preferably 0.10 to 0.26 μm.

Also, it is preferable that the color of reflected light in a CIE 1976 L*a*b* color space under a C-illuminant be set such that the value a* is −2 to 2, the value b* is −3 to 3, and the ratio of minimum and maximum values of the reflectance within a range of 380 nm to 780 nm is between 0.5 and 0.99, because, in this case, the color tone of the reflected light is neutral. Also, it is preferable to set the value b* of transmitted light under a C-illuminant at 0 to 3, because a yellowish tone on white display is reduced when the anti-glare and anti-reflection film of the present invention is applied to a display device.

Also, in optical characteristics of the anti-glare and anti-reflection film of the present invention, haze due to internal scattering (hereinafter, referred to as “internal haze”) of the anti-glare and anti-reflection film is 0% to 35%, preferably 0% to 30%, more preferably 0% to 10%, and most preferably 0% to 5%. Haze due to surface scattering (hereinafter, referred to as “surface haze”) is preferably 5% to 15%, more preferably 5% to 10%, and the sharpness of a transmitted image is preferably 5% to 30%, where a comb width is 0.5 mm, thereby making it possible to simultaneously achieve a satisfactory anti-glare property and improvements against image blurring and a contrast reduction in a dark room. Also, it is preferable that the specular reflectance be 2.5% or less and the transmittance be 90% or more, because the reflection of external light can be suppressed, leading to an improvement in visibility.

Next, the anti-glare layer will be described below.

(Anti-Glare Layer)

The anti-glare layer is formed for the purpose of providing a film with an anti-glare property resulted from surface scattering and a hard coat property for preferably improving abrasion resistance of the film. Accordingly, the anti-glare layer preferably contains, as essential components, a translucent resin for providing the hard coat property, a translucent microparticle for providing the anti-glare property, and a solvent.

(Translucent Microparticle)

The average particle size of the translucent microparticle is preferably 0.5 to 10 μm, more preferably 2.0 to 6.0 μm. It is not preferable that the average particle size be less than 0.5 μm, because the distribution of scattering angles of light extends to a wide angle, causing character blurring on a display. On the other hand, when the average particle size exceeds 10 μm, it is necessary to increase the thickness of the anti-glare layer, which causes problems, such as a large curl, an increase in material cost, and the like.

Specific preferable examples of the translucent microparticle include resin particles, such as poly((meth)acrylate) particles, crosslinkable poly((meth)acrylate) particles, polystyrene particles, crosslinkable polystyrene particles, crosslinkable poly(acryl-styrene) particles, melamine resin particles, benzoguanamine resin particles, and the like. Among them, the crosslinkable polystyrene particles, the crosslinkable poly((meth)acrylate) particles, and crosslinkable poly(acryl-styrene) particles are preferably used, and the refractive index of the translucent resin is adjusted in accordance with the refractive index of a translucent microparticle selected from among these particles, thereby attaining the internal haze, surface haze, and center line average roughness of the present invention. Specifically, it is preferable to combine a translucent resin (whose refractive index is 1.50 to 1.53 when cured) containing a below-described tri- or higher functional (meth)acrylate monomer, which is preferably used for the anti-glare layer of the present invention, with a translucent microparticle composed of a crosslinkable poly(meth)acrylate polymer whose acryl content is 50 to 100 percent by mass (preferably is 55 to 100 percent by mass, and more preferably is 60 to 100 percent by mass). Particularly, a combination of the translucent resin and a translucent microparticle (whose refractive index is 1.48 to 1.54) composed of a crosslinkable poly(styrene acryl) copolymer is preferable.

Also, two or more types of translucent microparticles of different particle sizes may be used in combination. A translucent microparticle having a larger particle size can provide an anti-glare property, and a translucent microparticle having a smaller particle size can reduce a surface roughness impression.

The translucent microparticle is preferably contained in the anti-glare layer in an amount of 3 to 30% by mass, more preferably 5 to 20% by mass, with respect to the total solid content of the anti-glare layer. When the amount of the translucent microparticle falls below 3% by mass, the anti-glare property becomes insufficient. When the amount of the translucent microparticle exceeds 30% by mass, a problem, such as image blurring, surface clouding, or glaring, occurs.

Also, the density of the translucent microparticle is preferably 10 to 2500 mg/m², more preferably 10 to 1000 mg/m², and even more preferably 100 to 700 mg/m².

The refractive index of the translucent resin of the present invention is preferably 1.45 to 1.70, more preferably 1.48 to 1.65. In order to control the refractive index of the anti-glare layer, the types and proportions of the translucent resin and the translucent microparticle may be selected as appropriate. Determination of the selection can be previously and readily found by experimentation.

Also, in the present invention, the absolute value of the difference in refractive index between the translucent resin and the translucent microparticle (the refractive index of the translucent microparticle—the refractive index of the translucent resin) is preferably 0.00 to 0.03, more preferably 0.00 to 0.02, and even more preferably 0.00 to 0.01. When the difference exceeds 0.03, a problem occurs, such as film character blurring, a contrast reduction in a dark room, surface clouding, or the like.

Also, the refractive index of the translucent resin is preferably 1.45 to 1.70, more preferably 1.48 to 1.65.

Also, the refractive index of the translucent microparticle is preferably is 1.42 to 1.70, more preferably 1.48 to 1.65.

Here, the refractive index of the translucent resin and the translucent microparticle can be quantitatively estimated by direct measurement with an Abbe refractometer or by performing spectral reflectance spectroscopy or spectroscopic ellipsometry, for example.

The thickness of the anti-glare layer is preferably 1 to 10 μm, more preferably 1.2 to 8 μm. The thickness is preferably in this range because if it is extremely thin, the hardness is insufficient, and if it is extremely thick, curling or brittleness increases, leading to a reduction in processability.

(Translucent Resin)

The translucent resin is preferably a binder polymer having, as its main chain, a saturated hydrocarbon chain or a polyether chain, more preferably, is a binder polymer having a saturated hydrocarbon chain as its main chain. Also, the binder polymer preferably has a crosslinked structure.

The translucent resin is preferably a polymer obtained from mainly preferably a di- or higher (more preferably tri- or higher) functional ionizing radiation curable compound. Here, the wording “mainly” means that the translucent resin includes the polymer in amount of 50 wt % or more. The content of polumer is more preferably 55 wt % or more, and most preferably 60 wt % or more.

The binder polymer having a saturated hydrocarbon chain as its main chain is preferably a polymer of an unsaturated ethylene monomer. The binder polymer having a saturated hydrocarbon chain as its main chain and a crosslinked structure is preferably a polymer (copolymer) of monomer(s) having two or more (preferably three or more) unsaturated ethylene groups.

For allowing the binder polymer to have a high refractive index, it is possible to select a high refractive index monomer containing, in its monomer structure, at least one type of atom selected from an aromatic ring, a halogen atom other than fluorine, a sulfur atom, a phosphorus atom, and a nitrogen atoms, a monomer having a fluorene backbone in its molecule, or the like.

Examples of the monomer having two or more unsaturated ethylene groups include esters of polyalcohol and (meth)acrylic acid (e.g., ethylene glycol di(meth)acrylate, butanediol di(meth)acrylate, hexanediol di(meth)acrylate, 1,4-cyclohexane diacrylate, pentaerythritol tetra(meth)acrylate, pentaerythritol tri(meth)acrylate, trimethylolpropane tri(meth)acrylate, trimethylolethane tri(meth)acrylate, dipentaerythritol tetra(meth)acrylate, dipentaerythritol penta(meth)acrylate, dipentaerythritol hexa(meth)acrylate, pentaerythritol hexa(meth)acrylate, 1,2,3-cyclohexane tetramethacrylate, polyurethane polyacrylate, and polyesters polyacrylate), modified ethylene oxides or modified caprolactones of the esters, vinyl benzene and derivatives thereof (e.g., 1,4-divinylbenzene, 4-vinylbenzoic acid-2-acryloyl ethyl esters, and 1,4-divinylcyclohexanone), vinyl sulfone (e.g., divinyl sulfone), acrylamide (e.g., methylene bisacrylamide) and methacrylamide. Two or more types of monomers may be used in combination.

Among the above, the translucent resin is preferably obtained from mainly a tri- or higher functional (meth)acrylate monomer. Here, the wording “mainly” means that monomers to be porimerized include the tri- or higher functional (meth)acrylate monomer in amount of 50 wt % or more. The content of such a monomer is more preferably 55 wt % or more, and most preferably 60 wt % or more.

Specific examples of the high refractive index monomers include (meth)acrylates having a fluorene backbone, bis(4-methacryloylthiophenyl)sulfide, vinylnaphthalene, vinyl phenyl sulfide, 4-methacryloxyphenyl-4′-methoxyphenylthioether, and the like. Two or more types of monomers may be used in combination.

The polymerization of the monomers having an unsaturated ethylene group can be carried out by irradiation with ionizing radiation or heating in the presence of a photoradical (polymerization) initiator or a thermal radical (polymerization) initiator.

Accordingly, the anti-glare layer can be formed by preparing a coating liquid which contains a monomer for forming a translucent resin, such as the above-described unsaturated ethylene monomers, a photoradical initiator or a thermal radical initiator, a translucent microparticle, and, as necessary, an inorganic filler as described below, applying the coating liquid onto a transparent support, and thereafter curing the liquid by a polymerization reaction induced by ionizing radiation or heat.

Examples of the photoradical (polymerization) initiator include acetophenones, benzoins, benzophenones, phosphine oxides, ketals, anthraquinones, thioxanthones, azo compounds, peroxides, 2,3-dialkyldione compounds, disulfide compounds, fluoro amine compounds, and aromatic sulfoniums. Examples of the acetophenones include 2,2-diethoxy acetophenone, p-dimethyl acetophenone, 1-hydroxydimethylphenylketone, 1-hydroxycyclohexyl phenyl ketone, 2-methyl-4-methylthio-2-morpholino propiophenone, and 2-benzyl-2-dimethyl amino-1-(4-morpholino phenyl)-butanone. Examples of the benzoins include benzoin benzenesulfonic acid esters, benzoin toluenesulfonic acid esters, benzoin methylether, benzoin ethyl ether, and benzoin isopropyl ether. Examples of the benzophenones include benzophenone, 2,4-dichlorobenzophenone, 4,4-dichlorobenzophenone, and p-chlorobenzophenone. Examples of the phosphine oxides include 2,4,6-trimethyl benzoyl diphenylphosphine.

Various examples which are useful for the present invention are described in “Saishin UV Kouka Gijyutsu (Latest UV Curing Technology)” (p. 159, publisher: Kazuhiro Takasusuki, publishing company: Technical Information Institute Co., Ltd., published in: 1991).

A preferable example of a commercially available photofragmentation-type photoradical polymerization initiator is IRGACURE (651, 184, 907) manufactured by Ciba Specialty Chemicals, or the like.

The photoradical (polymerization) initiator is preferably used in amount of 0.1 to 15 parts by mass, more preferably 1 to 10 parts by mass, with respect to 100 parts by mass of polyfunctional monomer.

In addition to the photoradical (polymerization) initiator, a photosensitizer may be used. Specific examples of the photosensitizer include n-butylamine, triethylamine, tri-n-butyl phosphine, Michler's ketone, and thioxanthone.

As the thermal radical initiator, organic or inorganic peroxides, organic azo and diazo compounds, and the like, can be used.

Specifically, examples of the organic peroxides include benzoyl peroxide, halogenated benzoyl peroxide, lauroyl peroxide, acetyl peroxide, dibutyl peroxide, cumene hydroperoxide, and butyl hydroperoxide. Examples of the inorganic peroxide include hydrogen peroxide, ammonium persulfate, potassium persulfate, and the like. Examples of the azo compounds include 2-azo-bis-isobutyronitrile, 2-azo-bis-propionitrile, 2-azo-bis-cyclohexane dinitrile, and the like. Examples of the diazo compound include diazoaminobenzene, p-nitrobenzenediazonium, and the like.

The polymer having polyether as its main chain is preferably a ring-opened polymer of a polyfunctional epoxy compound. The ring-opening polymerization of the polyfunctional epoxy compound can be carried out by irradiation with ionizing radiation or heating in the presence of a photo-acid generator or a thermal acid generator.

Accordingly, an optical diffusion layer can be formed by preparing a coating liquid which contains the polyfunctional epoxy compound, the photo-acid generator or the thermal acid generator, the translucent microparticle, and an inorganic filler, and applying the coating liquid onto the transparent support, and curing the liquid by a polymerization reaction induced by ionizing radiation or heating.

Instead of or in addition to the monomer having two or more unsaturated ethylene groups, a monomer having a crosslinkable functional group may be used to introduce a crosslinkable functional group into the polymer and induce a reaction of the crosslinkable functional group, thereby introducing a crosslinked structure into the binder polymer.

Examples of the crosslinkable functional group include an isocyanate group, an epoxy group, an aziridine group, an oxazoline group, an aldehyde group, a carbonyl group, a hydrazine group, a carboxyl group, a methylol group, and an active methylene group. Vinyl sulfone acids, acid anhydrides, cyanoacrylate derivatives, melamine, etherified methylol, esters, urethane, and metal alkoxides (e.g., tetramethoxysilane, etc.) can also be used as the monomer for introducing a crosslinked structure. A functional group, such as a block isocyanate group, which exhibits crosslinkability as a result of a decomposition reaction, may be used. Accordingly, in the present invention, the crosslinkable functional group may exhibit reactivity as a result of decomposition even if it exhibits no immediate reaction.

These binder polymers having a crosslinkable functional group can form a crosslinked structure by heating after application.

In order to adjust the refractive index of the anti-glare layer and thereby to reduce the value of haze which is caused due to internal scattering, the anti-glare layer may contain, in addition to the translucent microparticle, an inorganic filler which is composed of an oxide of at least one type of metal selected from silicon, titanium, zirconium, aluminum, indium, zinc, tin, and antimony, and has an average particle size of 0.2 μm or less, preferably 0.1 μm or less, more preferably 0.06 μm or less. The inorganic filler generally has a specific gravity higher than specific gravities of organic substances, and can increase the density of a coating composition, and therefore, the filler can achieve the effect of slowing the sedimentation rate of the translucent microparticle.

A surface of the inorganic filler used for the anti-glare layer is preferably subjected to silane coupling treatment or titanium coupling treatment, and a surface-treatment agent having a functional group reactable with binder species is preferably applied to the filler surface.

In the case of using the inorganic filler, the added amount thereof is preferably 10 to 90%, more preferably 20 to 80%, and particularly preferably 30 to 75%, with respect to the total weight of the anti-glare layer.

Note that such an inorganic filler has a particle size sufficiently smaller than the wavelength of light, so that no scattering is caused, and a dispersion element in which the filler is dispersed in a binder polymer behaves as an optically homogeneous material.

Also, an organosilane compound (preferably, at least one of the hydrolysate of organosilane represented by the formula (1) and the partial condensate thereof) can be used in the anti-glare layer. The amount of the organosilane compound to be added is preferably 0.001 to 50% by mass, more preferably 0.01 to 20% by mass, with respect to the total solid content of the anti-glare layer.

(Surfactant for Anti-Glare Layer)

In order to ensure the uniform surface state against, in particular, uneven coating, uneven drying, a point defect, or the like, the anti-glare layer of the present invention preferably has either or both of fluorine-based and silicone-based surfactants contained in a coating composition for use in forming an anti-glare layer. Particularly, the fluorine-based surfactant is preferably used because the addition of a smaller amount thereof suppresses a defective surface state, such as uneven coating, uneven drying, a point defect, or the like, of the anti-glare and anti-reflection film of the present invention.

The purpose thereof is to increase the uniformity of a surface state and provide the suitability for high-speed coating, thereby increasing the productivity.

A preferable example of the fluorine-based surfactant is a fluoroaliphatic group-containing copolymer (which may be abbreviated as a “fluorine-based polymer”), and the fluorine-based polymer is an acryl or methacrylic resin which contains a repeating unit corresponding to a monomer described in (i) below or a copolymer with a vinyl monomer (e.g. a monomer described in (ii) below) copolymerizable therewith.

(i) Fluoroaliphatic Group-Containing Monomer Represented by the Following General Formula A

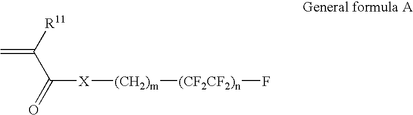

In general formula A, R¹¹ denotes a hydrogen atom or a methyl group, X denotes an oxygen atom, a sulfur atom, or —N(R¹²)—, m denotes an integer from 1 to 6, and n denotes an integer from 2 to 4. R¹² denotes a hydrogen atom or an alkyl group having one to four carbon atoms (specifically, a methyl group, an ethyl group, a propyl, or a butyl group), preferably a hydrogen atom or a methyl group. X is preferably an oxygen atom.

(ii) Monomer Copolymerizable With the Above (i), Represented by the Following General Formula B

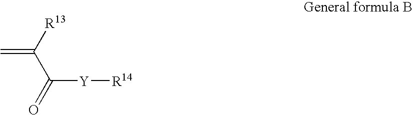

In general formula B, R¹³ denotes a hydrogen atom or a methyl group, and Y denotes an oxygen atom, a sulfur atom, or —N(R¹⁵)—. R¹⁵ denotes a hydrogen atom or alkyl having one to four carbon atoms (specifically, a methyl group, an ethyl group, a propyl group, or a butyl group), preferably a hydrogen atom or a methyl group. Y is preferably an oxygen atom, —N(H)—, or N(CH³)—.

R¹⁴ denotes a straight-chain, branched, or cyclic alkyl group having four to twenty carbon atoms, which may have a substituent group. Examples of the substituent group for alkyl of R¹⁴ include, but not limited to, a hydroxy group, an alkyl carbonyl group, an aryl carbonyl group, a carboxyl group, an alkyl ether group, an aryl ether group, a halogen atom (e.g., a fluorine atom, a chlorine atom, a bromine atom, etc.), nitro, a cyano group, an amino group, and the like. As the straight-chain, branched, or cyclic alkyl group having four to twenty carbon atoms, a butyl group, a pentyl group, a hexyl group, a heptyl group, an octyl group, a nonyl group, a decyl group, an undecyl group, a dodecyl group, a tridecyl group, a tetradecyl group, a pentadecyl group, an octadecyl group, or an eicosanyl group, which may be straight-chained or branched, or a monocyclic cycloalkyl group, such as a cyclohexyl group, a cycloheptyl group, or the like, or a polycyclic cycloalkyl group, such as a bicycloheptyl group, a bicyclodecyl group, a tricycloundecyl group, a tetracyclododecyl group, an adamanthyl group, a norbomyl group, a tetracyclodecyl group, or the like, is preferably used.

The amount of the fluoroaliphatic group-containing monomer represented by general formula A and used in the fluorine-based polymer for use in the present invention is in an amount of 10 mol % or more, preferably 15 to 70 mol %, and more preferably 20 to 60 mol %, based on each monomer of the fluorine-based polymer.

The preferable mass-average molecular weight of the fluorine-based polymer for use in the present invention is preferably 3,000 to 100,000, more preferably 5,000 to 80,000.

Further, from the viewpoint of the effect of the fluorine-based polymer, or the viewpoint of the drying of coating and the performance as the coating (e.g., reflectance and abrasion resistance), the preferable amount of the fluorine-based polymer for use in the present invention is in the range from 0.001 to 5% by mass, preferably 0.005 to 3% by mass, and even more preferably 0.01 to 1% by mass, with respect to the coating liquid.

Specific exemplary structures of the fluorine-based polymer composed of the fluoroaliphatic group-containing monomer represented by general formula A are shown below. The present invention is not limited to these examples. Note that numbers in the following formulas indicate a molar ratio of monomer components, and Mw indicates a mass-average molecular weight.

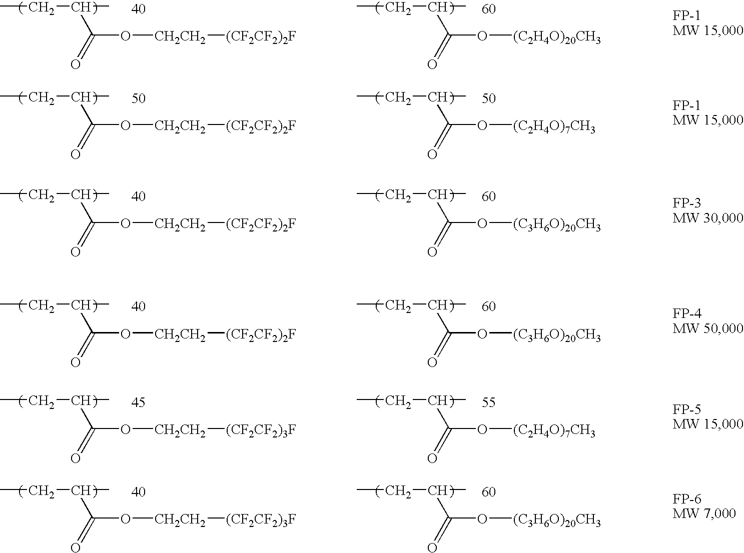

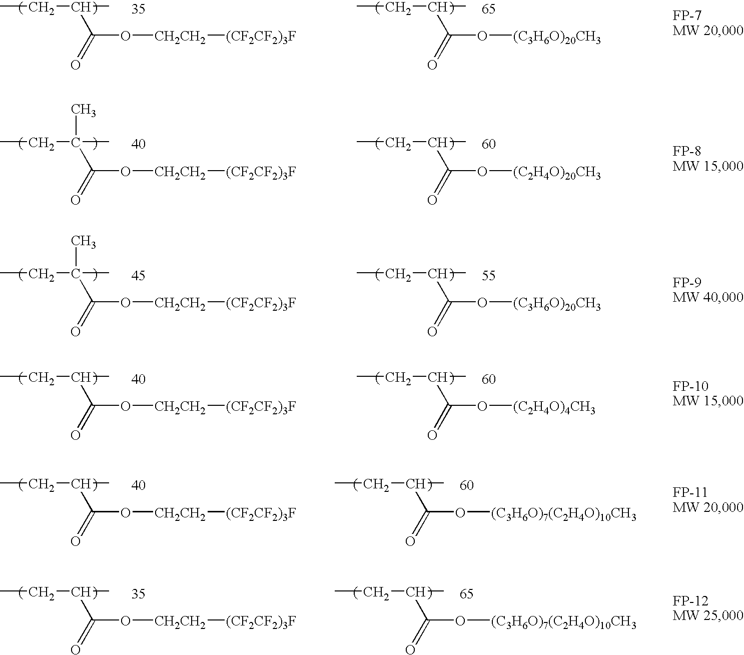

However, by using the fluorine-based polymer as described above, an F atom-containing functional group is caused to segregate on a surface of the anti-glare layer, leading to a reduction in the surface energy of the anti-glare layer, and causing a deterioration in the anti-reflection property when the anti-glare layer is overcoated with a low refractive index layer. It is presumed that this is due to a deterioration in the wettability of a curable composition used for forming the low refractive index layer, which increases fine roughness of the low refractive index layer which cannot be visually observed. The present inventors found that in order to solve such a problem, it is effective to adapt the structure and added amount of the fluorine-based polymer to control the surface energy of the anti-glare layer to be preferably 20 mN·m⁻¹ to 50 mN·m⁻¹, more preferably 30 mN·m⁻¹ to 40 mN·m⁻. In order to realize the surface energy as described above, an F/C ratio of peaks derived from fluorine and carbon atoms, which is measured by X-ray photoelectron spectroscopy, needs to be 0.1 to 1.5.

Alternatively, the above purpose can also be achieved by selecting, when applying an upper layer, a fluorine-based polymer which can be extracted into a solvent for forming the upper layer, so that uneven distribution does not occur on a surface (=interface) of a lower layer, to provide tight adhesion ability between the upper and lower layers, thereby even in the case of high-speed coating, maintaining the uniformity of a surface state and providing an anti-glare and anti-reflection film with high abrasion resistance. By preventing a reduction in the surface free energy, it is possible to control the surface energy of the anti-glare layer to fall within the above range before the application of the low refractive index layer. An example of such a material is an acryl or methacrylic resin which is characterized by containing a repeating unit corresponding to a fluoroaliphatic group-containing monomer represented by general formula C shown below, and a copolymer thereof with a vinyl monomer (i.e. monomer represented by general formula D below) copolymerizable therewith.

(iii) Fluoroaliphatic Group-Containing Monomer Represented by the Following General Formula C

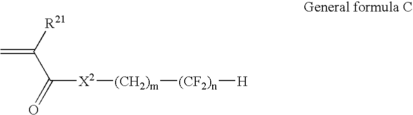

In general formula C, R²¹ denotes a hydrogen atom, a halogen atom, or a methyl group, more preferably a hydrogen atom and a methyl group. X² denotes an oxygen atom, a sulfur atom, or —N(R²²)—, more preferably an oxygen atom and —N(R²²)—, and even more preferably an oxygen atom. “m” is an integer from 1 to 6 (more preferably 1 to 3, and even more preferably 1), and n is an integer from 1 to 18 (more preferably 4 to 12, and even more preferably 6 to 8). R²² denotes a hydrogen atom or an alkyl group having one to eight carbon atoms, which may have a substituent group, more preferably a hydrogen atom and an alkyl group having one to four carbon atoms, and even more preferably a hydrogen atom or a methyl group. X is preferably an oxygen atom.

Also, the fluorine-based polymer may contain, as its components, two or more types of fluoroaliphatic group-containing monomers represented by general formula C.

(iv) Monomer Copolymerizable With the Above (iii), Represented by the Following General Formula D

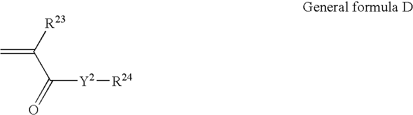

In general formula D, R²³ denotes a hydrogen atom, a halogen atom, or a methyl group, more preferably a hydrogen atom and a methyl group. Y² denotes an oxygen atom, a sulfur atom, or —N(R²⁵)—, more preferably an oxygen atom and —N(R²⁵)—, and even more preferably an oxygen atom. R²⁵ denotes a hydrogen atom or an alkyl group having one to eight carbon atoms, more preferably a hydrogen atom and an alkyl group having one to four carbon atoms, and even more preferably a hydrogen atom and a methyl group.

R²⁴ denotes a straight-chain, branched, or cyclic alkyl group having one to twenty carbon atoms, which may have a substituent group, an alkyl group including a poly(alkyleneoxy) group, or an aromatic group (e.g., a phenyl group or a naphthyl group) which may have a substituent group, more preferably a straight-chain, branched, or cyclic alkyl group having one to twelve carbon atoms and an aromatic group whose total number of carbon atoms is 6 to 18, and even more preferably a straight-chain, branched, or cyclic alkyl group having one to eight carbon atoms.

Specific exemplary structures of a fluorine-based polymer including a repeating unit corresponding to the fluoroaliphatic group-containing monomer represented by general formula C are shown below. The present invention is not limited to these examples. Note that numbers in the following formulas indicate a molar ratio of monomer components, and Mw indicates a mass-average molecular weight.

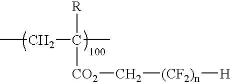

| | R | n | Mw |
|---|---|---|---|
| P-1 | H | 4 | 8000 |
| P-2 | H | 4 | 16000 |
| P-3 | H | 4 | 33000 |
| P-4 | CH₃ | 4 | 12000 |
| P-5 | CH₃ | 4 | 28000 |
| P-6 | H | 6 | 8000 |
| P-7 | H | 6 | 14000 |
| P-8 | H | 6 | 29000 |
| P-9 | CH₃ | 6 | 10000 |
| P-10 | CH₃ | 6 | 21000 |
| P-11 | H | 8 | 4000 |
| P-12 | H | 8 | 16000 |
| P-13 | H | 8 | 31000 |
| P-14 | CH₃ | 8 | 3000 |

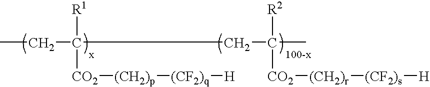

| | x | R¹ | p | q | R² | r | s | Mw |
|---|---|---|---|---|---|---|---|---|
| P-15 | 50 | H | 1 | 4 | CH₃ | 1 | 4 | 10000 |
| P-16 | 40 | H | 1 | 4 | H | 1 | 6 | 14000 |
| P-17 | 60 | H | 1 | 4 | CH₃ | 1 | 6 | 21000 |
| P-18 | 10 | H | 1 | 4 | H | 1 | 8 | 11000 |
| P-19 | 40 | H | 1 | 4 | H | 1 | 8 | 16000 |
| P-20 | 20 | H | 1 | 4 | CH₃ | 1 | 8 | 8000 |
| P-21 | 10 | CH₃ | 1 | 4 | CH₃ | 1 | 8 | 7000 |
| P-22 | 50 | H | 1 | 6 | CH₃ | 1 | 6 | 12000 |
| P-23 | 50 | H | 1 | 6 | CH₃ | 1 | 6 | 22000 |
| P-24 | 30 | H | 1 | 6 | CH₃ | 1 | 6 | 5000 |

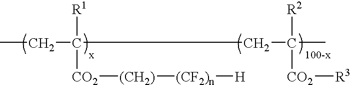

| | x | R¹ | n | R² | R³ | Mw |
|---|---|---|---|---|---|---|
| FP-148 | 80 | H | 4 | CH₃ | CH₃ | 11000 |
| FP-149 | 90 | H | 4 | H | C₄H₉ (n) | 7000 |
| FP-150 | 95 | H | 4 | H | C₆H₁₃ (n) | 5000 |
| FP-151 | 90 | CH₃ | 4 | H | CH₂CH(C₂H₅)C₄H₉ (n) | 15000 |
| FP-152 | 70 | H | 6 | CH₃ | C₂H₅ | 18000 |
| FP-153 | 90 | H | 6 | CH₃ | 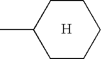 | 12000 |
| FP-154 | 80 | H | 6 | H | C₄H₉ (sec) | 9000 |
| FP-155 | 90 | H | 6 | H | C₁₂H₂₅ (n) | 21000 |
| FP-156 | 60 | CH₃ | 6 | H | CH₃ | 15000 |
| FP-157 | 60 | H | 8 | H | CH₃ | 10000 |
| FP-158 | 70 | H | 8 | H | C₂H₅ | 24000 |
| FP-159 | 70 | H | 8 | H | C₄H₉ (n) | 5000 |
| FP-160 | 50 | H | 8 | H | C₄H₉ (n) | 16000 |
| FP-161 | 80 | H | 8 | CH₃ | C₄H₉ (iso) | 13000 |
| FP-162 | 80 | H | 8 | CH₃ | C₄H₉ (t) | 9000 |
| FP-163 | 60 | H | 8 | H | 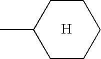 | 7000 |
| FP-164 | 80 | H | 8 | H | CH₂CH(C₂H₆)C₄H₉ (n) | 8000 |
| FP-165 | 90 | H | 8 | H | C₁₂H₂₅ (n) | 6000 |
| FP-166 | 80 | CH₃ | 8 | CH₃ | C₄H₉ (sec) | 18000 |
| FP-167 | 70 | CH₃ | 8 | CH₃ | CH₃ | 22000 |
| FP-168 | 70 | H | 10 | CH₃ | H | 17000 |
| FP-169 | 90 | H | 10 | H | H | 9000 |

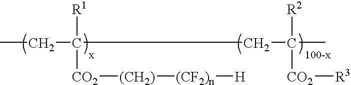

| | x | R¹ | n | R² | R³ | Mw |
|---|---|---|---|---|---|---|
| FP-170 | 95 | H | 4 | CH₃ | —(CH₂CH₂O)₂—H | 18000 |
| FP-171 | 80 | H | 4 | H | —(CH₂CH₂O)₂—CH₃ | 16000 |
| FP-172 | 80 | H | 4 | H | —(C₈H₆O)₇—H | 24000 |
| FP-173 | 70 | CH₃ | 4 | H | —(C₃H₆O)₁₃—H | 18000 |
| FP-174 | 90 | H | 6 | H | —(CH₂CH₂O)₂—H | 21000 |
| FP-175 | 90 | H | 6 | CH₃ | —(CH₂CH₂O)₈—H | 9000 |
| FP-176 | 80 | H | 6 | H | —(CH₂CH₂O)₂—C₄H₉ (n) | 12000 |
| FP-177 | 80 | H | 6 | H | —(C₈H₆O)₇—H | 34000 |
| FP-178 | 75 | F | 6 | H | —(C₃H₆O)₁₃—H | 11000 |
| FP-179 | 85 | CH₃ | 6 | CH₃ | —(C₃H₆O)₂₀—H | 18000 |
| FP-180 | 95 | CH₃ | 6 | CH₃ | —CH₂CH₂OH | 27000 |
| FP-181 | 80 | H | 8 | CH₃ | —(CH₂CH₂O)₃—H | 12000 |
| FP-182 | 95 | H | 8 | H | —(CH₂CH₂O)₉—CH₃ | 20000 |
| FP-183 | 90 | H | 8 | H | —(C₉H₆O)₇—H | 8000 |
| FP-184 | 95 | H | 8 | H | —(C₃H₆O)₂₀—H | 15000 |
| FP-185 | 90 | F | 8 | H | —(C₃H₆O)₁₃—H | 12000 |
| FP-186 | 80 | H | 8 | CH₃ | —(CH₂CH₂O)₂—H | 20000 |
| FP-187 | 95 | CH₃ | 8 | H | —(CH₂CH₂O)₉—CH₃ | 17000 |
| FP-188 | 90 | CH₃ | 8 | H | —(C₃H₆O)₇—H | 34000 |
| FP-189 | 80 | H | 10 | H | —(CH₂CH₂O)₃—H | 19000 |
| FP-190 | 90 | H | 10 | H | —(C₃H₆O)₇—H | 8000 |
| FP-191 | 80 | H | 12 | H | —(CH₂CH₂O)₇—CH₃ | 7000 |
| FP-192 | 95 | CH₃ | 12 | H | —(C₃H₆O)₇—H | 10000 |

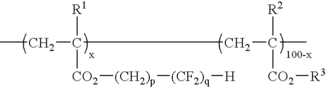

| | x | R¹ | p | q | R² | R³ | Mw |
|---|---|---|---|---|---|---|---|
| FP-193 | 80 | H | 2 | 4 | H | C₄H₉ (n) | 18000 |
| FP-194 | 90 | H | 2 | 4 | H | —(CH₂CH₂O)₉—CH₃ | 16000 |
| FP-195 | 90 | CH₃ | 2 | 4 | F | C₆H₁₃ (n) | 24000 |
| FP-196 | 80 | CH₃ | 1 | 6 | F | C₄H₉ (n) | 18000 |
| FP-197 | 95 | H | 2 | 6 | H | —(C₃H₆O)₇—H | 21000 |
| FP-198 | 90 | CH₃ | 3 | 6 | H | —CH₂CH₂OH | 9000 |
| FP-199 | 75 | H | 1 | 8 | F | CH₃ | 12000 |
| FP-200 | 80 | H | 2 | 8 | H | CH₂CH(C₂H₆)C₄H₉ (n) | 34000 |
| FP-201 | 90 | CH₃ | 2 | 8 | H | —(C₃H₆O)₇—H | 11000 |
| FP-202 | 80 | H | 3 | 8 | CH₃ | CH₃ | 18000 |
| FP-203 | 90 | H | 1 | 10 | F | C₄H₉ (n) | 27000 |
| FP-204 | 95 | H | 2 | 10 | H | —(CH₂CH₂O)₉—CH₃ | 12000 |
| FP-205 | 85 | CH₃ | 2 | 10 | CH₃ | C₄H₉ (n) | 20000 |
| FP-206 | 80 | H | 1 | 12 | H | C₆H₁₃ (n) | 8000 |
| FP-207 | 90 | H | 1 | 12 | H | —(C₃H₆O)₁₃—H | 15000 |
| FP-208 | 60 | CH₃ | 3 | 12 | CH₃ | C₂H₆ | 12000 |
| FP-209 | 60 | H | 1 | 16 | H | CH₂CH(C₂H₅)C₄H₉ (n) | 20000 |
| FP-210 | 80 | CH₃ | 1 | 16 | H | —(CH₂CH₂O)₂—C₄H₉ (n) | 17000 |
| FP-211 | 90 | H | 1 | 18 | H | —CH₂CH₂OH | 34000 |
| FP-212 | 60 | H | 3 | 18 | CH₃ | CH₃ | 19000 |

Also, by preventing reduction of the surface energy at the time of overcoating the anti-glare layer with the low refractive index layer, deterioration of the anti-reflection property can be prevented. The above purpose can also be achieved by using a fluorine-based polymer, when applying the anti-glare layer, to reduce the surface tension of a coating liquid and thereby to increase the uniformity of a surface state and maintain the high productivity resulted from high-speed coating, and employing, after the application of the anti-glare layer, a surface treatment technique, such as corona treatment, UV treatment, heat treatment, saponification treatment, or solvent treatment (particularly preferable is corona treatment) to prevent reduction of the surface free energy and thereby to control the surface energy of the anti-glare layer to fall within the above range before applying the low refractive index layer.

Also, the coating composition for forming the anti-glare layer of the present invention may additionally contain a thixotropy agent. Examples of the thixotropy agent include silica, mica, and the like, which are 0.1 μm or less in size. Typically, the content of the additive is preferably about 1 to 10 parts by mass with respect to 100 parts by mass of an ultraviolet curable resin.

Next, the low refractive index layer will be described below.

(Low Refractive Index Layer)

The refractive index of the low refractive index layer in the anti-reflection film of the present invention is in the range from 1.30 to 1.55, preferably in the range from 1.35 to 1.45.

When the refractive index is within the above range, anti-reflection performance is enhanced without reducing the mechanical strength of the film.

Further, satisfying the following expression (I) is preferable for the low refractive index layer in terms of reducing the reflectance.

Expression (I): (mλ/4)×0.7<n1×d1<(mλ/4)×1.3

In the expression, m is a positive odd number, n1 is the refractive index of the low refractive index layer, and d1 is the thickness (nm) of the low refractive index layer. Also, λ is a wavelength having a value in the range from 500 to 550 nm.

Note that satisfying the expression (I) means that m (positive odd number, typically 1) satisfying the expression (I) is present in the above wavelength range.

The material that forms the low refractive index layer will be described below.

The low refractive index layer is a cured film which is formed by applying, drying, and curing a curable composition containing, for example, a fluorinated polymer as a major component. (Here, the wording “containing . . . as a major component” means that the curable composition includes the fluorinated polymer in an amount of 50 wt % or more. The content of the fluorinated polymer is more preferably 55 wt % or more, and most preferably 60 wt % or more.)

(Fluorinated Polymer for Low Refractive Index Layer)

In the case where, for example, a roll of film is subjected to coating and curing while being transported in the form of a web, it is preferable in terms of improvement of the productivity that the fluorinated polymer, when cured into a coating, have a coefficient of dynamic friction of 0.03 to 0.20, a contact angle against water of 90 to 120°, and a sliding angle of pure water of 70° or less, and also the polymer is crosslinkable by heat or ionizing radiation.

Also, in the case where the anti-reflection film of the present invention is attached to an image display device, the lower the force required for detaching a commercially-available adhesive tape, the easier it is to detach an affixed sticker or memo. Therefore, the force required for detachment is preferably 500 gf or less, more preferably 300 gf or less, and most preferably 100 gf or less. It is not preferable that the force fall below 0.1 gf, because a surface protection laminate film is likely to be easily detached when applied to, for example, a polarizing plate or a display device. Also, the higher the surface hardness measured by a microhardness meter, the less likely the film is scratched. Accordingly, the surface hardness is preferably 0.3 GPa or more, more preferably 0.5 GPa or more.

The fluorinated polymer used for the low refractive index layer is a fluorinated polymer containing fluorine atoms in an amount of 35 to 80% by mass (more preferably 45 to 75% by mass), and a crosslinkable or polymerizable functional group. Examples of the fluorinated polymer include, in addition to hydrolysates of perfluoroalkyl group-containing silane compounds (e.g., (heptadecafluoro-1,1,2,2-tetrahydrodecyl)triethoxysilane) and dehydrated condensates thereof, fluorinated copolymers having a fluorinated monomeric unit and a crosslinkable reactiv unit as structural units. In the case of a fluorinated copolymer, the main chain thereof is preferably composed only of carbon atoms. That is, the main chain backbone preferably contains no oxygen or nitrogen atoms.

Specific examples of the fluorinated monomeric unit include fluoroolefins (e.g., fluoroethylene, vinylidenefluoride, tetrafluoroethylene, perfluorooctyl ethylene, hexafluoropropylene, and perfluoro-2,2-dimethyl-1,3-dioxole), partially or completely fluorinated alkyl ester derivatives of (meth)acrylic acid (e.g., Viscoat 6FM (manufactured by Osaka Organic Chemical Industry, Ltd.), M-2020 (manufactured by Daikin Industries, Ltd.), etc.), completely or partially fluorinated vinyl ethers, and the like. Perfluoroolefins are preferable, and hexafluoropropylene is particularly preferable from the viewpoint of refractive index, solubility, translucency, availability, and the like.

Examples of the crosslinkable reactive unit include: a structural unit obtained by polymerization of a monomer, such as glycidyl methacrylate or glycidyl vinyl ether, which originally has a self-crosslinkable functional group in its molecule; and a structural unit obtained through a polymer reaction by which a crosslinkable reactive group, such as (meth)acryloyl or the like, is introduced into a structural unit obtained by polymerization of a monomer having a carboxyl group, a hydroxy group, an amino group, a sulfo group, or the like (e.g., (meth)acrylic acid, methylol (meth)acrylate, hydroxyalkyl (meth)acrylate, allyl acrylate, hydroxyethyl vinyl ether, hydroxybutyl vinyl ether, maleic acid, crotonic acid, etc.) (note that the introduction can be carried out by, for example, a method of reacting acrylic acid chloride with a hydroxy group).

Also, in addition to the fluorinated monomeric unit and the crosslinkable reactive unit, other polymeric units can be introduced by suitably copolymerizing a monomer containing no fluorine atom, from the viewpoint of the solubility to a solvent, the translucency of the coating, and the like. The monomeric unit which can be used in combination with the fluorinated monomeric unit is not particularly limited. Examples of such a monomeric unit include olefines (ethylene, propylene, isoprene, vinyl chloride, vinylidene chloride, etc.), acrylic acid esters (acrylic acid methyl, acrylic acid methyl, acrylic acid ethyl, and acrylic acid 2-ethyl hexyl), methacrylic acid esters (methacrylic acid methyl, methacrylic acid ethyl, methacrylic acid butyl, ethylene glycol dimethacrylate, etc.), styrene derivatives (styrene, divinyl benzene, vinyl toluene, α-methylstyrene, etc.), vinyl ethers (methyl vinyl ether, ethyl vinyl ether, cyclohexyl vinyl ether, etc.), vinyl esters (vinyl acetate, vinyl propionate, vinyl cinnamate, etc.), acrylamides (N-tertbutylacrylamide, N-cyclohexylacrylamide, etc.), methacrylamides, acrylonitrile derivatives, and the like.

The fluorinated polymer may be used as appripriate in combination with a curing agent as described in Japanese Unexamined Patent Publication Nos. H10-25388 and H10-147739.

The fluorinated polymer which is particularly useful in the present invention is a random copolymer of perfluoroolefine with vinyl ethers or vinyl esters. It is particularly preferable that the fluorinated polymer have a group crosslinkable by itself (e.g., a radical reactive group, such as (meth)acryloyl or the like, and a ring-opening polymerizable group, such as an epoxy group, an oxetanyl group, or the like).

These crosslinkable group-containing polymeric units preferably account for 5 to 70 mol %, particularly preferably 30 to 60 mol %, with respect to all the polymeric units of the fluorinated polymer.

A preferable form of the fluorinated polymer for a low refractive index layer for use in the present invention is a copolymer represented by general formula 1.

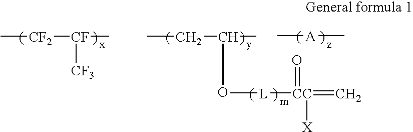

In general formula 1, L denotes a linking group having one to ten carbon atoms, more preferably a linking group having one to six carbon atoms, and particularly preferably two to four linking groups, and may have a straight-chain, branched, or cyclic structure, and may have a heteroatom selected from among 0, N, and S.

Preferable examples of L include *—(CH₂)₂—O—**, *—(CH₂)₂—NH—**, *—(CH₂)₄—O—**, *—(CH₂)₆—O—**, *—(CH₂)₂—O—(CH₂)₂—O—**, *—CONH—(CH₂)₃—O—**, *—CH₂CH(OH)CH₂—O—**, *—CH₂CH₂OCONH(CH₂)₃—O—**, and the like (where * denotes a link site on the polymer main chain side, and ** denotes a link site on the (meth)acryloyl group side). “m” denotes 0 or 1.

In general formula 1, X denotes a hydrogen atom or a methyl group. From the viewpoint of curing reactivity, a hydrogen atom is more preferable.

In general formula 1, A denotes a repeating unit derived from any vinyl monomer, which is not limited as long as it is a monomer copolymerizable with hexafluoropropylene, and can be selected as appropriate in view of various factors, such as adhesion ability to a base material, a Tg of the polymer (which contributes to coating hardness), solubility to a solvent, translucency, a slippery property, a dust-/stain-proof property, and the like. The repeating unit may be composed of a single or a plurality of vinyl monomers, depending on the purpose.

Preferable examples of A include vinyl ethers, such as methyl vinyl ether, ethyl vinyl ether, t-butyl vinyl ether, cyclohexyl vinyl ether, isopropyl vinyl ether, hydroxyethyl vinyl ether, hydroxybutyl vinyl ether, glycidyl vinyl ether, aryl vinyl ether, and the like; vinyl esters, such as vinyl acetate, vinyl propionate, vinyl butyrate, and the like; (meth)acrylates, such as methyl (meth)acrylate, ethyl (meth)acrylate, hydroxyethyl (meth)acrylate, glycidyl methacrylate, furyl (meth)acrylate, (meth)acryloyloxypropyltrimethoxysilane, and the like; styrene derivatives, such as styrene, p-hydroxymethylstyrene, and the like; unsaturated carbonic acids, such as crotonic acid, maleic acid, itaconic acid, and the like, and derivatives thereof; and the like. Vinyl ether derivatives and vinyl esters derivatives are more preferable, and vinyl ether derivatives are particularly preferable.

“x”, “y”, and “z” denote mol % of components, preferably 30≦x≦60, 5≦y≦70, and 0≦z≦65, even more preferably 35≦x≦55, 30≦y≦60, and 0≦z≦20, and particularly preferably 40≦x≦55, 40≦y≦55, and 0≦z≦10. Note that x+y+z=100.

A particularly preferable form of the copolymer for use in the present invention is represented by, for example, general formula 2.

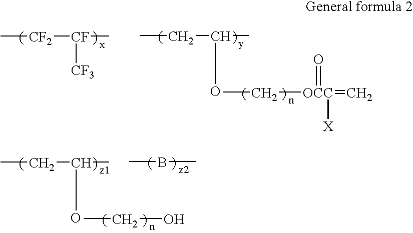

In general formula 2, X denotes the same as in general formula 1, and the preferable range thereof is also the same.

“n” denotes an integer in the range of 2≦n≦10, preferably in the range of 2≦n≦6, and particularly preferably in the range of 2≦n≦4.

B denotes a repeating unit derived from any vinyl monomers, which may be composed of a single composition or a plurality of compositions. B includes the above-described examples of A in general formula 1.

“x”, “y”, “z1”, and “z2” denote mol % of repeating units, “x” and “y” preferably satisfy 30≦x≦60 and 5≦y≦70, respectively, more preferably 35≦x≦55 and 30≦y≦60, and particularly preferably 40≦x≦55 and 40≦y≦55. “z1” and “z2” preferably satisfy 0≦z1≦65 and 0≦z2≦65, more preferably 0≦z1≦30 and 0≦z2≦10, and particularly preferably 0≦z1≦10 and 0≦z2≦5. Note that x+y+z1+z2=100.

The copolymer represented by general formula 1 or 2 can be synthesized by, for example, introducing (meth)acryloyl into a copolymer containing hexafluoropropylene and hydroxyalkyl vinyl ether components using any of the above-described methods. The reprecipitation solvent used therefor is preferably isopropanol, hexane, methanol, or the like.

Specific preferable examples of the copolymer represented by general formula 1 or 2 include those described in [0035] to [0047] of Japanese Unexamined Patent Publication No. 2004-45462, and they can be synthesized by a method described therein.

The curable composition preferably contains: (A) the fluorinated polymer; (B) an inorganic microparticle; and (C) an organosilane compound described below.

(Inorganic Microparticles for Low Refractive Index Layer)

The blended amount of the inorganic microparticle is preferably 1 mg/m² to 100 mg/m², more preferably 5 mg/m² to 80 mg/m², and even more preferably 10 mg/m² to 60 mg/m². If the amount is extremely low, the effect of improving the abrasion resistance is reduced. If the amount is extremely high, fine roughness occurs on a surface of the low refractive index layer, likely leading to a deterioration in external appearance, such as black density or the like, and a reduction in integrated reflectance. Therefore, the above-described range is preferable.

The inorganic microparticle is contained in the low refractive index layer, and therefore, preferably have a low refractive index. Examples thereof include microparticles of magnesium fluoride and silica. In particular, the inorganic microparticle mainly comprises a silica microparticle (Here, the wording “mainly” means that the inorganic microparticles includes the silica microparticle in amount of 50 wt % or more. The content of the silica microparticle is more preferably 55 wt % or more, and most preferably 60 wt % or more.) in terms of refractive index, dispersion stability, and cost.

The average particle size of the inorganic microparticles is preferably 30% to 100%, more preferably 35% to 80%, and even more preferably 40% to 60%, with respect to the thickness of the low refractive index layer. In other words, when the thickness of the low refractive index layer is 100 nm, the particle size of the silica microparticle is preferably 30 nm to 100 nm, more preferably 35 nm to 80 nm, and even more preferably, 40 nm to 60 nm.

When the particle size of the inorganic microparticle is within the above-described range, the effect of improving the abrasion resistance is satisfactory, and in addition, fine roughness is unlikely to occur on the surface of the low refractive index layer, leading to improvements in external appearance, such as black density or the like, and integrated reflectance.

The inorganic microparticle may be either crystalline or amorphous, and may also be a monodisperse particle, or an aggregated particle as long as it satisfies a predetermined particle size. The shape thereof is most preferably spherical but any irregular shape causes no disadvantage.

The average particle size of the inorganic microparticle is herein measured by a Coulter counter.

In order to further reduce an increase in the refractive index of the low refractive index layer, the inorganic microparticle preferably has a hollow structure, and a refractive index of 1.17 to 1.40, more preferably 1.17 to 1.35, and even more preferably 1.17 to 1.30. The refractive index as used herein means the total refractive index of the particles, but not the refractive index of only an inorganic substance of an outer shell of the hollow structured inorganic microparticle. In this case, assuming that the radius of a void in the particle is a and the radius of the outer shell of the particle is b, the void fraction x represented by the following expression (II) is preferably 10 to 60%, more preferably 20 to 60%, and most preferably 30 to 60%.

Expression (II): x=(4πa³/3)/(4πb³/3)×100

When the void fraction is increased so as to reduce the refractive index of the hollow inorganic microparticle, the thickness of the outer shells becomes thinner, reducing the strength of the particle. From the viewpoint of abrasion resistance, a particle having a low refractive index of less than 1.17 is useless.

Note that the refractive index of the inorganic microparticle was measured by an Abbe refractometer (manufactured by Atago Co., Ltd.).

Also, at least one type of inorganic microparticle which has an average particle size of less than 25% of the thickness of the low refractive index layer (hereinafter, referred to as a “small size inorganic microparticle”) may be used in combination with an inorganic microparticles having a particle size within the above preferable range (hereinafter, referred to as a “large size inorganic microparticle”).

The small size inorganic microparticle can be present in a gap between each large size inorganic microparticle, and therefore, can contribute as an agent for holding the large size inorganic microparticle.

In the case where the low refractive index layer is 100 nm in thickness, the average particle size of the small size inorganic microparticle is preferably 1 nm to 20 nm, more preferably 5 nm to 15 nm, and particularly preferably 10 nm to 15 nm. The use of such an inorganic microparticle is preferable in terms of material cost and the effect as a holding agent.

As described above, as the inorganic microparticle, one which has an average particle size of 30 to 100% of the thickness of the low refractive index layer as described above, a hollow structure, and a refractive index of 1.17 to 1.40 as described above, is particularly preferably used.

The inorganic microparticle may be subjected to physical surface treatment, such as plasma discharge treatment or corona discharge treatment, or chemical surface treatment with a surfactant, a coupling agent, or the like, in order to stabilize its dispersion in a dispersion or coating liquid or enhance its affinity for or adhesion ability to a binder component. The use of a coupling agent is particularly preferable. As the coupling agent, an alkoxy metal compound (e.g., a titanium coupling agent or a silane coupling agent) is preferably used. Among them, silane coupling treatment is particularly effective.

The coupling agent may be used as a surface treatment agent for the inorganic microparticle of the low refractive index layer in order to perform surface treatment before preparing the layer coating liquid. Preferably, the coupling agent may be further added as an additive when preparing the coating liquid, so that the coupling agent can be contained in the layer.

The inorganic microparticle is preferably dispersed in a medium before the surface treatment in order to reduce the load of the surface treatment.

Next, the organosilane compound (C) will be described.

(Organosilane Compound For Low Refractive Index Layer)

It is preferable that the curable composition contain at least either a hydrolysate of an organosilane compound or a partial condensate thereof (hereinafter, an obtained reaction solution is also referred to as a “sol component”) in terms of abrasion resistance, and in particular, ensuring of both the anti-reflection property and the abrasion resistance.

The sol component is condensed to form a cured material when the curable composition is applied, followed by drying and heating, and as a result, acts as a binder for the low refractive index layer. Also, in the present invention, the fluorinated polymer is contained, and therefore, a binder having a three-dimensional structure is formed by irradiation of active light.

The organosilane compound is preferably one which is represented by the following general formula (1).

General formula (1): (R¹⁰)ₘSi(X)₄₋ₘ

In general formula (1), R¹⁰ denotes a substituted or unsubstituted alkyl group or a substituted or unsubstituted aryl group. Examples of the alkyl group include a methyl group, an ethyl group, a propyl group, an isopropyl group, a hexyl group, a decyl group, a hexadecyl group, and the like. The alkyl group preferably has one to thirty carbon atoms, more preferably one to sixteen carbon atoms, and particularly preferably one to six carbon atoms. The aryl group is a phenyl group, a naphtyl group, or the like, preferably a phenyl group.

X denotes a hydroxy group or a hydrolyzable group. Preferable examples of X include alkoxy groups (preferably, an alkoxy group having one to five carbon atoms, e.g., a methoxy group, an ethoxy group, etc.), halogen atoms (e.g., Cl, Br, I, etc.), and R²COO (where R² is preferably a hydrogen atom or an alkyl group having one to five carbon atoms, e.g., CH³COO, C²H⁵COO, etc.). Alkoxy groups are preferable, and a methoxy group or an ethoxy group is particularly preferable.

“m” denotes an integer from 1 to 3, preferably 1 or 2, and particularly preferably 1.

When a plurality of R¹⁰'s or X's exist, the plurality of R¹⁰'s or X's may be the same or different from each other.

Examples of a substituent contained in R¹⁰ include, but are not limited to, halogen atoms (e.g., fluorine, chlorine, bromine, etc.), a hydroxy group, a mercapto group, a carboxyl group, an epoxy group, alkyl groups (e.g., methyl, ethyl, i-propyl, propyl, t-butyl, etc.), aryl groups (e.g., phenyl, naphthyl, etc.), aromatic heterocyclic groups (e.g., furyl, pyrazolyl, pyridyl, etc.), alkoxy groups (e.g., methoxy, ethoxy, i-propoxy, hexyloxy, etc.), aryloxy (e.g., phenoxy, etc.), alkylthio groups (e.g., methylthio, ethylthio, etc.), arylthio groups (e.g., phenylthio, etc.), alkenyl groups (e.g., vinyl, 1-propenyl, etc.), acyloxy groups (e.g., acetoxy, acryloyloxy, methacryloyloxy, etc.), alkoxycarbonyl groups (e.g., methoxycarbonyl, ethoxycarbonyl, etc.), aryloxycarbonyl groups (e.g., phenoxycarbonyl, etc.), carbamoyl groups (e.g., carbamoyl, N-methylcarbamoyl, N,N-dimethylcarbamoyl, N-methyl-N-octylcarbamoyl, etc.), acylamino groups (e.g., acetylamino, benzoylamino, acrylamino, methacrylamino, etc.), and the like. These substituents may be further substituted.

When a plurality of R¹⁰'s exist, at least one of them is preferably a substituted alkyl group or a substituted aryl group.

The hydrolysate of organosilane represented by the formula (1) and the partial condensate thereof are preferably a vinyl-polymerizable substituent represented by the following general formula (2).

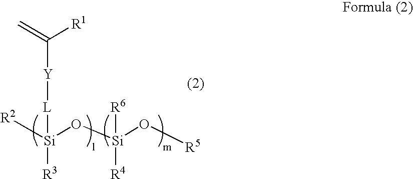

In the above formula (2), R¹ represents a hydrogen atom, methyl group, methoxy group, alkoxycarbonyl group, cyano group, fluorine atom or chlorine atom. As the alkoxycarbonyl group, methoxycarbonyl, ethoxycarbonyl, etc. are mentioned. Preferably, R¹ represents a hydrogen atom, methyl group, methoxycarbonyl group, cyano group, a fluorine atom or chlorine atom, and more preferably represents a hydrogen atom or methyl.

Y represents a single bond, *—COO—**, *—CONH—** or *—O—**, preferably a single bond, *—COO—** or *—CONH—**, still more preferably a single bond or *—COO—**, and particularly preferably *—COO—**. The mark * represents the position at which the group connects to ═C(R¹)——, and the mark ** represents the position at which the group connects to L.

L represents a di-valent connecting chain. Specifically, L represents a substituted or unsubstituted alkylene group, a substituted or unsubstituted arylene group, a substituted or unsubstituted alkylene group having therein a connecting group (for example, ether, ester, amide, etc.), or a substituted or unsubstituted arylene group having therein a connecting group. Preferably L represents a substituted or unsubstituted alkylene group, a substituted or unsubstituted arylene group or an alkylene group having therein a connecting group. More preferably, L represents an unsubstituted alkylene group, an unsubstituted arylene group or an alkylene group having therein an ether or ester connecting group, and particularly preferably an unsubstituted alkylene group or an alkylene group having therein an ether or ester connecting group. As the substituent, a halogen, hydroxy group, mercapto group, carboxyl group, epoxy group, alkyl group, aryl group, etc. are mentioned. These substituents may further be substituted.

1 and m each represents a molar fraction (1 represents a numeral satisfying the numerical formula 1=100−m), and m represents a numeral of from 0 to 50. m represents more preferably a numeral of from 0 to 40, and particularly preferably a numeral of from 0 to 30.

R² to R⁴ each preferably represent a halogen atom, hydroxy group, an unsubstituted alkoxy group or an unsubstituted alkyl group. R² to R⁴ each represent more preferably a chlorine atom, hydroxy group or an alkoxy group with 1 to 6 carbon atoms, still more preferably a hydroxy group or an alkoxy group with 1 to 3 carbon atoms, and particularly preferably a hydroxy group or methoxy group.

R⁵ represents a hydrogen atom or an alkyl group, among which methyl or ethyl is preferred.

R⁶ represents an substituted or unsubstituted alkyl group, or an substituted or unsubstituted aryl group.

By way of precaution, the aforementioned hydrolyzed product and/or its partial condensation product represented by formula (2) may be the hydrolyzed product and/or its partial condensation product of a mixture of plural kinds of the compounds represented by formula (2) each having specified 1 and m.

The weight-average molecular weight of the compond represented by formula (2) is preferably 450 to 20,000, more preferably 500 to 10,000, further more preferably 550 to 5,000, and most preferably 600 to 3,000 in the case where a component having a weight-average molecular weight of less than 300 which is gerenated in a process of the systhesis is removed.

The compound represented by formula (2) is synthesized with use of one or more silane compounds as the starting materials. In the following, specific examples of the silane compound as the starting material for the synthesis of the compound represented by formula (2) are enumerated, but the present invention is not limited to these examples.

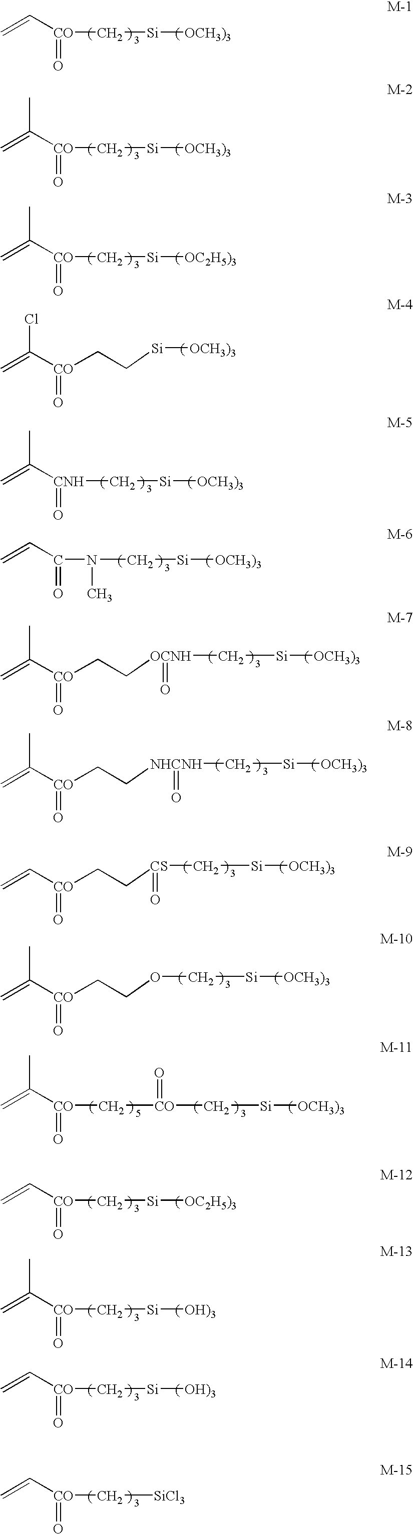

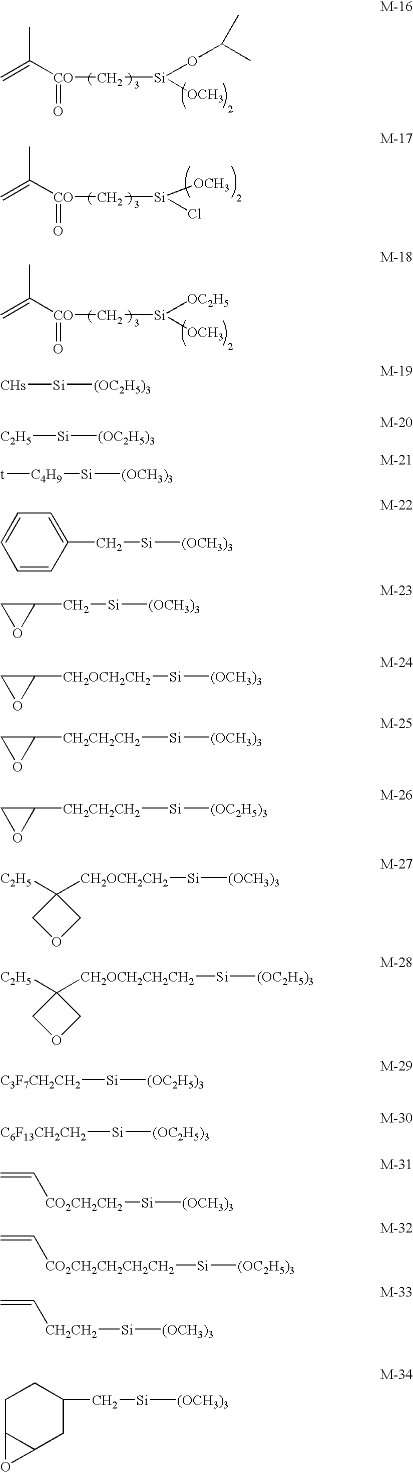

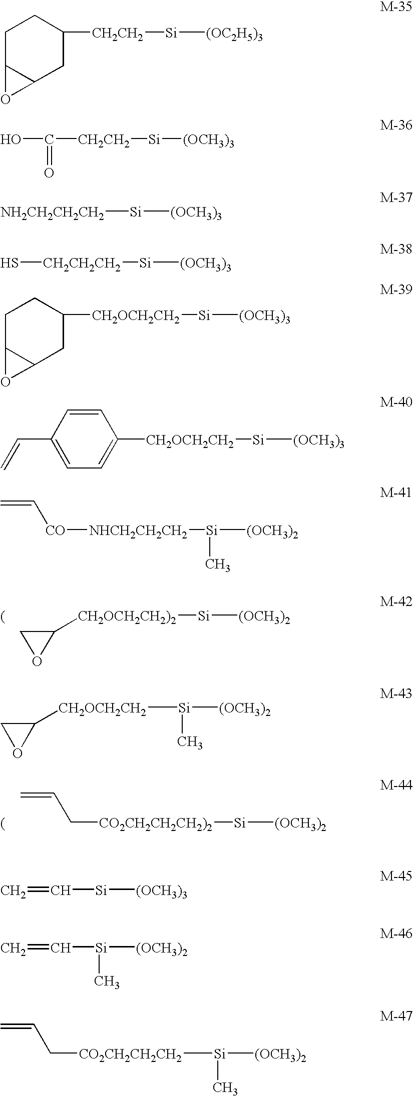

M-48: CH₃—Si(OCH₃)₃

M-49: C₂H₅—Si(OCH₃)₃

M-50: t-C₄H₉—Si(OCH₃)₃

Among these, it is particularly preferred to use (M-1), (M-2), (M-25), (M-48) or (M-49) as the starting material. Details of the synthetic method will be described later.

It is preferred to suppress the volatility of at lease one of the hydrolysate of organosilane and the partial condensate thereof according to the present invention for the purpose of stabilization of the performance of the coated product. Specifically, the volatilized quantity per 1 hr at 105° C. is preferably 5 mass % or less, more preferably 3 mass % or less, particularly preferably 1 mass % or less.

The hydrolysate and partial condensate of the organosilane compound are typically produced by treating the organosilane compound in the presence of a catalyst. Examples of the catalyst include: inorganic acids, such as hydrochloric acid, sulfuric acid, nitric acid, and the like; organic acids, such as oxalic acid, acetic acid, formic acid, methane sulfonic acid, toluene sulfonic acid, and the like; inorganic bases, such as sodium hydroxide, potassium hydroxide, ammonia, and the like; organic bases, such as triethylamine, pyridine, and the like; metal alkoxides, such as triisopropoxy aluminum, tetrabutoxy zirconium, and the like; metal chelate compounds containing, as a central metal, a metal, such as Zr, Ti, Al, or the like; and the like. In the present invention, the use of metal chelate compounds and acid catalysts, such as inorganic acids and organic acids, are preferable. Preferable inorganic acids are hydrochloric acid and sulfuric acid, and preferable organic acids are those having an acid dissociation constant (pKa value (25° C.)) of 4.5 or less in water. Hydrochloric acid, sulfuric acid, and organic acids having an acid dissociation constant of 3.0 or less in water are more preferable. Hydrochloric acid, sulfuric acid, and organic acids having an acid dissociation constant of 2.5 or less in water are particularly preferable. Organic acids having an acid dissociation constant of 2.5 or less in water are even more preferable. Specifically, methane sulfonic acid, oxalic acid, phthalic acid, and malonic acid are even more preferable. Oxalic acid is particularly preferable.

The metal chelate compound is not particularly limited, and any metal chelate compound can be used as appropriate as long as the compound has, as a central metal, a metal selected from Zr, Ti, and Al, and also has, as ligands, an alcohol represented by the general formula R⁷OH (where R⁷ denotes an alkyl group having one to ten carbon atoms) and a compound represented by the general formula R⁸COCH₂COR⁹ (where R⁸ denotes an alkyl group having one to ten carbon atoms, and R⁹ denotes an alkyl group having one to ten carbon atoms or an alkoxy group having one to ten carbon atoms). If the above condition is satisfied, two or more types of metal chelate compounds may be used in combination. The metal chelate compound for use in the present invention is preferably selected from the group consisting of compounds represented by the general formulas Zr(OR⁷)ₚ₁(R⁸COCHCOR⁹)ₚ₂, Ti(OR⁷)_{q1}(R⁸COCHCOR⁹)_{q2}, and Al(OR⁷)ᵣ₁(R⁸COCHCOR⁹)ᵣ₂, and has a function of accelerating a condensation reaction of the hydrolysate and partial condensate of the organosilane compound.

In the metal chelate compound, R⁷ and R⁸ may be the same or different from each other, and each denote an alkyl group having one to ten carbon atoms, such as, specifically, an ethyl group, an n-propyl group, an i-propyl group, an n-butyl group, a sec-butyl group, a t-butyl group, an n-pentyl group, a phenyl group, or the like. R⁹ denotes an alkyl group having one to ten carbon atoms as defined above, or an alkoxy group having one to ten carbon atoms, such as a methoxy group, an ethoxy group, an n-propoxy group, an i-propoxy group, an n-butoxy group, a sec-butoxy group, a t-butoxy group, or the like. Also, in the metal chelate compound, p1, p2, q1, q2, r1, and r2 denote integers which satisfy p1+p2=4, q1+q2=4, and r1+r2=3.

Specific examples of these metal chelate compounds include: zirconium chelate compounds, such as tri-n-butoxyethyl acetoacetate zirconium, di-n-butoxybis(ethylacetoacetate)zirconium, n-butoxytris(ethylacetoacetate)zirconium, tetrakis(n-propylacetoacetate)zirconium, tetrakis(acetylacetoacetate)zirconium, tetrakis(ethylacetoacetate)zirconium, and the like; titanium chelate compounds, such as diisopropoxy bis(ethylacetoacetate)titanium, diisopropoxy bis(acetylacetate)titanium, diisopropoxy bis(acetylacetone)titanium, and the like; aluminum chelate compounds, such as diisopropoxy ethylacetoacetate aluminum, diisopropoxy acetylacetonato aluminum, isopropoxybis(ethylacetoacetate)aluminum, isopropoxybis(acetylacetonato)aluminum, tris(ethylacetoacetate)aluminum, tris(acetylacetonato)aluminum, monoacetylacetonato bis(ethylacetoacetate)aluminum, and the like; and the like.

Among these metal chelate compounds, tri-n-butoxyethyl acetoacetate zirconium, diisopropoxybis(acetylacetonato)titanium, diisopropoxy ethylacetoacetate aluminum, and tris(ethylacetoacetate)aluminum are preferable. These metal chelate compounds can be used singly or in combination of two or more. Also, partial hydrolysates of these metal chelate compounds can be used.

Also, in the present invention, the curable composition preferably further contains at least either a β-diketone compound or a β-ketoester compound. A further description will be given below.

The present invention uses at least either a β-diketone or β-ketdester compound represented by the general formula R⁸COCH₂COR⁹, which acts as an agent for enhancing the stability of the curable composition used in the present invention. Here, R⁸ denotes an alkyl group having one to ten carbon atoms, and R⁹ denotes an alkyl group having one to ten carbon atoms or an alkoxy group having one to ten carbon atoms. That is, it is considered that the β-diketone or β-ketoester compound binds to a metal atom in the metal chelate compound (at least either zirconium, titanium, or aluminum compounds) to suppress the function of the metal chelate compound that accelerates a condensation reaction of at least either a hydrolysate of the organosilane compound or a partial condensate thereof, thereby enhancing the stability in preservation of a resultant composition. R⁸ and R⁹ constituting the β-diketone compound and the β-ketoester compound are similar to R⁸ and R⁹ constituting the metal chelate compound.

Specific examples of the β-diketone and β-ketoester compounds include acetylacetone, methyl acetoacetate, ethyl acetoacetate, acetoacetic-n-propyl, acetoacetic-i-propyl, acetoacetic-n-butyl, acetoacetic-sec-butyl, acetoacetic-t-butyl, 2,4-hexane-dion, 2,4-heptane-dion, 3,5-heptane-dion, 2,4-octane-dion, 2,4-nonane-dion, 5-methyl-hexane-dion, and the like. Among them, ethyl acetoacetate and acetylacetone are preferable, and acetylacetone is particularly preferable. The β-diketone and β-ketoester compounds can be used singly or in combination of two or more.

In the present invention, from the viewpoint of the stability in preservation of the composition, β-diketone and β-ketoester compounds are used preferably in an amount of 2 mols or more, more preferably 3 to 20 mols, per mol of the metal chelate compound.

The blended amount of the organosilane compound is preferably in an amount of 0.1 to 50% by mass, more preferably 0.5 to 20% by mass, and most preferably 1 to 10% by mass, with respect to the total solid content of the low refractive index layer.

The organosilane compound may be directly added to curable compositions (coating liquids for anti-glare layer, low refractive index layer, and the like), but it is preferable that the organosilane compound be previously treated in the presence of a catalyst to prepare at least either a hydrolysate of the organosilane compound or a partial condensate thereof, and the resultant reaction solution (sol liquid) is used to prepare the curable composition. In the present invention, preferably, a composition containing either a hydrolysate of the organosilane compound or a partial condensate thereof and a metal chelate compound is first prepared, at least either the β-diketone compound or the β-ketoester compound is added thereto to obtain a liquid, and the liquid is causes to be contained in a coating liquid for at least one layer, i.e., the anti-glare layer or the low refractive index layer, and is applied.

The amount of a sol component of organosilane that is used with respect to the fluorinated polymer in the low refractive index layer is preferably 5 to 100% by mass, more preferably 5 to 40% by mass, even more preferably 8 to 35% by mass, and particularly preferably 10 to 30% by mass. When the use amount is within the above range, the effect of the present invention is readily achieved, the refractive index is appropriate, and in addition, the shape and surface state of the film are satisfactory.

An inorganic filler other than the above-mentioned inorganic microparticles can be added to the curable composition in an amount so as not to adversely affect the desired effect of the present invention. The details of the inorganic filler will be described below.

(Other Substances Contained in Curable Composition for Low Refractive Index Layer)

The curable composition is produced by adding, as necessary, various additives and a radical polymerization initiator or a cationic polymerization initiator to the above-described components: (A) a fluorinated polymer; (B) an inorganic microparticle; and (C) an organosilane compound, and further by dissolving them in an appropriate solvent. In this case, the solid content concentration is selected as appropriate, depending on the purpose of use, and is generally about 0.01 to 60% by mass, preferably 0.5 to 50% by mass, and particularly preferably about 1% to 20% by mass.

From the viewpoint of, for example, the interface adhesion ability between the low refractive index layer and an underlying layer in direct contact therewith, a small amount of curing agent, such as a polyfunctional (meth)acrylate compound, a polyfunctional epoxy compound, a polyisocyanate compound, aminoplast, polybasic acid or anhydride thereof, or the like, may be added. When they are added, the amount thereof is preferably 30% by mass or less, more preferably 20% by mass or less, and particularly preferably 10% by mass or less, with respect to the total solid content of the coating of the low refractive index layer.

Also, in order to provide a property, such as a stain-proof property, a waterproof property, a chemical resistant property, a slippery property, or the like, a stain-proofing agent, a lubricant, or the like, such as a known silicone-based compound or fluorine-based compound or the like, may be added as appropriate. When these additives are added, the added amount thereof is preferably 0.01 to 20% by mass, more preferably 0.05 to 10% by mass, and particularly preferably 0.1 to 5% by mass, with respect to the total solid content of the low refractive index layer.

Preferable examples of the silicone-based compound include those containing a plurality of dimethyl silyloxy units as repeating units and having a substituent group at least either at a chain terminal or at a side chain. The compound containing dimethyl silyloxy as a repeating unit may contain a structural unit other than dimethyl silyloxy in its chain. The same or different substituent groups may be contained. A plurality of substituent groups are preferably contained. Preferable examples of the substituent group include an acryloyl group, a methacryloyl group, a vinyl group, an aryl group, a cinnamoyl group, an epoxy group, an oxetanyl group, a hydroxy group, a fluoroalkyl group, a polyoxyalkylene group, a carboxyl group, an amino group, and the like. The molecular weight is not particularly limited, but is preferably 100,000 or less, particularly preferably 50,000 or less, and most preferably 3,000 to 30,000. The amount of silicon atoms contained in the silicone-based compound is not particularly limited, but is preferably 18.0% by mass or more, particularly preferably 25.0 to 37.8% by mass, and most preferably 30.0 to 37.0% by mass. Preferable examples of the silicone-based compound include, but are not limited to, X-22-174DX, X-22-2426, X-22-164B, X22-164C, X-22-170DX, X-22-176D, and X-22-1821 (trade names; manufactured by Shin-etsu Chemical Co., Ltd.), FM-0725, FM-7725, FM-4421, FM-5521, FM6621, and FM-1121 (trade names; manufactured by CHISSO CORPORATION)), and DMS-U22, RMS-033, RMS-083, UMS-182, DMS-H21, DMS-H31, HMS-301, FMS121, FMS123, FMS131, FMS141, and FMS221 (trade names; manufactured by Gelest), and the like.

The fluorine-based compound is preferably a compound having a fluoroalkyl group. The fluoroalkyl group preferably has one to twenty carbon atoms, more preferably one to ten carbon atoms, and may have a straight-chain structure (e.g., —CF₂CF₃, —CH₂(CF₂)₄H, —CH₂(CF₂)₈CF₃, —CH₂CH₂(CF₂)₄H, etc.), a branched structure (e.g., —CH(CF₃)₂, —CH₂CF(CF₃)₂, —CH(CH₃)CF₂CF₃, —CH(CH₃)(CF₂)₅CF₂H, etc.), or an alicyclic structure (preferably a 5- or 6-membered ring; e.g., a perfluorocyclohexyl group, a perfluorocyclopentyl group, or an alkyl group substituted therewith), or may have an ether linkage (e.g., —CH₂OCH₂CF₂CF₃, —CH₂CH₂OCH₂C₄F₈H, —CH₂CH₂OCH₂CH₂C₈F₁₇, —CH₂CH₂OCF₂CF₂OCF₂CF₂H, etc.). A plurality of fluoroalkyl groups may be contained in the same molecule.

Further, the fluorine-based compound preferably contains a substituent group which contributes to bonding or compatibility with respect to the coating of the low refractive index layer. The substituent groups may be same or different from each other. A plurality of substituent groups are preferably contained. Preferable examples of the substituent group include an acryloyl group, a methacryloyl group, a vinyl group, an aryl group, a cinnamoyl group, an epoxy group, oxetanyl group, a hydroxy group, a polyoxyalkylene group, a carboxyl group, an amino group, and the like. The fluorine-based compound may be a polymer or oligomer with a compound containing no fluorine atom, and the molecular weight thereof is not particularly limited. The amount of fluorine atoms contained in the fluorine-based compound is not particularly limited, but is preferably 20% by mass or more, particularly preferably 30 to 70% by mass, and most preferably 40 to 70% by mass. Preferable examples of the fluorine-based compound include, but are not limited to, R-2020, M-2020, R-3833, and M-3833 (trade names; manufactured by Daikin Industries, Ltd.) and MEGAFACE F-171, F-172, F-179A, DEFENSA MCF-300 (trade names; manufactured by Dainippon Ink & Chemicals, Inc.), and the like.

In order to provide a property, such as a dust-proofing property, an antistatic property, or the like, a dust-proofing agent, an antistatic agent, or the like, such as a known cation surfactant or polyoxyalkylene-based compound or the like, may be added as appropriate. The dust-proofing agent and the antistatic agent may have their structural units contained in the above-described silicone-based compound or fluorine-based compound as part of their functions. When they are added as additives, the added amount is preferably 0.01 to 20% by mass, more preferably 0.05 to 10% by mass, and particularly preferably 0.1 to 5% by mass, with respect to the total solid content of the low refractive index layer. Preferable examples of the compound include, but are not limited to, MEGAFACE F-150 (trade name; manufactured by Dainippon Ink & Chemicals, Inc.), SH-3748 (trade name; manufactured by Dow Corning Toray Co., Ltd.), and the like.

(Transparent Support)

A plastic film is preferably used as a transparent support for the anti-glare and anti-reflection film of the present invention. Examples of a polymer for forming the plastic film include cellulose acylate (e.g., triacetylcellulose, diacetylcellulose, cellulose acetate propionate, and cellulose acetate butyrate, which are typified by TAC-TD80U, TD80UL, etc., manufactured by Fuji Photo Film Co., Ltd.), polyamide, polycarbonate, polyesters (e.g., polyethylene terephthalate, polyethylene, and naphthalate), polystyrene, polyolefine, norbornene-based resin (ARTON: trade name; manufactured by JSR Corp.), amorphous polyolefine (ZEONEX: trade name; manufactured by ZEON Corp.), and the like. Among them, triacetylcellulose, polyethylene terephthalate, norbornene-based resin, and amorphous polyolefine are preferable, and triacetylcellulose is particularly preferable.

Cellulose acylate is composed of a single layer or a plurality of layers. Cellulose acylate of a single layer is prepared by drum casting as disclosed in Japanese Unexamined Patent Publication No. H07-11055 or band casting or the like, and the latter cellulose acylate of a plurality of layers is prepared by a so-called co-casting method as disclosed in Japanese Unexamined Patent Publication No. S61-94725, and Japanese Examined Patent Publication No. S62-43846. Specifically, a raw material flake is dissolved using a solvent, such as halogenated hydrocarbons (e.g., dichloromethane, etc.), alcohols (e.g., methanol, ethanol, butanol, etc.), esters (e.g., methyl formate, methyl acetate, etc.), ethers (e.g., dioxane, dioxolane, diethyl ether, etc.). If desired, various additives, such as a plasticizer, an ultraviolet absorbent, a deterioration inhibitor, a lubricant, a detachment accelerator, and the like, are added thereto. The resultant solution (referred to as a “dope”) is cast on a support including a horizontal endless metal belt or a rotating drum, by a dope supplying means (referred to as a “die”). At this time, a single dope is solely cast in the case of a single layer, and a high-concentration cellulose ester dope and low-concentration dopes on opposite sides thereof are co-cast in the case of a plurality of layers. The dope is dried on the support to some extent, the film thus imparted with rigidity is detached from the support, and the film is passed through a drying section by various transportation means to remove the solvent.

A representative example of the solvent for dissolving cellulose acylate is dichloromethane. However, from the viewpoint of the global environment or the working environment, the solvent preferably contains substantially no halogenated hydrocarbon, such as dichloromethane or the like. The term “contain substantially no halogenated hydrocarbon” as used herein means that the proportion of halogenated hydrocarbon in the organic solvent is less than 5% by mass (preferably less than 2% by mass).

The above-described various cellulose acylate films (films composed of triacetylcellulose and the like) and a production method thereof are described in Journal of Technical Disclosure No. 2001-1745 issued by Japan Institute of Invention and Innovation (Mar. 15, 2001).

The thickness of the cellulose acylate film is preferably 40 μm to 120 μm. In consideration of handling suitability, application suitability, and the like, about 80 μm is preferable. However, the recent years have seen the trend toward thinner display devices, and there is a great need for thinner polarizing plates. From the viewpoint of reducing polarizing plates in thickness, about 40 μm to 60 μm is preferable. When such a thin cellulose acylate film is used as a transparent support for the anti-glare and anti-reflection film of the present invention, it is preferable to avoid problems concerning handling suitability, application suitability, and the like, by optimizing a solvent, film thickness, crosslinking shrinkage, and the like of a layer directly applied onto the cellulose acylate film.

(Other Layers)

Examples of other layers which can be provided between the transparent support and the anti-glare layer of the present invention, include an antistatic layer (if a display requires a reduction in a surface resistance value or if dust on a surface or the like cause a trouble), a hard coat layer (if hardness is not satisfactory when only the anti-glare layer is used), an anti-moisture layer, an adhesion improvement layer, an anti-rainbow pattern (interference pattern) layer.

These layers can be formed by known methods.

The anti-glare and anti-reflection film of the present invention can be formed by a method described below. The present invention is not limited to this method.

(Preparation of Coating Liquid)

First, a coating liquid containing components for forming layers is prepared. At this time, the volatilization volume of a solvent is minimized to suppress an increase in water content of the coating liquid. The water content of the coating liquid is preferably 5% or less, more preferably 2% or less. The minimization of the volatilization volume of the solvent is achieved by, for example, enhancing the sealing effect at the time of agitating materials introduced into a tank and minimizing the area of the coating liquid which is brought into contact with air when decanting the liquid. Also, a means for reducing the water content of the coating liquid during the application or before/after the application may be provided.

The coating liquid for forming the anti-glare layer is preferably filtered to remove almost all (90% or more) foreign substances corresponding to a dry thickness (about 50 nm to 120 nm) of the low refractive index layer which is directly formed thereon. A translucent microparticle for providing a light diffusion property is as thick as or thicker than the low refractive index layer, and therefore, the filtering is preferably performed on an intermediate liquid having contained therein all materials other than the translucent microparticle. Also, in the case where it is not possible to obtain a filter capable of removing foreign substances having a small particle size, it is preferable to perform filtering to remove almost all foreign substances at least corresponding to a wet thickness (about 1 to 10 μm) of the layer which is to be directly formed thereon. With such a means, it is possible to reduce a point defect in the layer directly formed thereon.

(Application)

Next, a coating liquid for forming the anti-glare layer, and optionally, the low refractive index layer is applied onto the transparent support by a coating method, such as an extrusion method (a die coating method), a microgravure method, or the like, followed by heating and drying. Thereafter, by means of at least light irradiation or heating, a monomer and a curable resin for forming the anti-glare layer to the low refractive index layer are cured. In this manner, the anti-glare layer to the low refractive index layer is formed.

In order to produce the anti-glare and anti-reflection film of the present invention with high productivity, an extrusion method (a die coating method) is preferably employed. A die coater will be described which is particularly preferably used for an areas the wet coating amount of which is small (20 cc/m² or less), e.g., the anti-glare layer and the anti-reflection layer of the present invention.

FIG. 2 is a cross-sectional view of a coater using a slot die according to the present invention. A coater 10 applies a coating liquid 14 from a slot die 13 in the form of a bead 14a onto a continuously moving web W supported by a backup roll 11, thereby forming a coating film 14b on the web W.

A pocket 15 and a slot 16 are formed in the slot die 13. The pocket 15 has a cross section formed by curved and straight lines, which may be, for example, a substantially circular form as illustrated in FIG. 2 or a semi-circular form. The pocket 15 is a coating liquid reservoir having a cross-sectional shape elongated in a width direction of the slot die 13, and an effective elongated length thereof is typically equal to or slightly longer than a width of coating. The coating liquid 14 is supplied into the pocket 15 from a side surface of the slot die 13 or from the center of the surface that is opposite to a slot opening portion 16a. Also, the pocket 15 is provided with a stopper for preventing leakage of the coating liquid 14.

The slot 16 is a flow passage of the coating liquid 14 from the pocket 15 to the web W, and has, similar to the pocket 15, a cross-sectional shape elongated in the width direction of the slot die 13, and the opening portion 16a disposed on the web side is typically adjusted in width by using a width regulating plate or the like (not shown), so as to have a width substantially equal to the width of coating. The angle made between the slot tip of the slot 16 and a tangent line in the web moving direction of the backup roll 11 is preferably from 30° to 90°.

A tip lip 17 of the slot die 13 at which the opening portion 16a of the slot 16 is disposed is formed in a tapered shape, and the tip is a flat portion 18 which is called “land”. A portion of the land 18 upstream in the traveling direction of the web W with respect to the slot 16 is referred to as an “upstream-side lip land 18a”, and a downstream portion of the land 18 is referred to as a “downstream-side lip land 18b”.

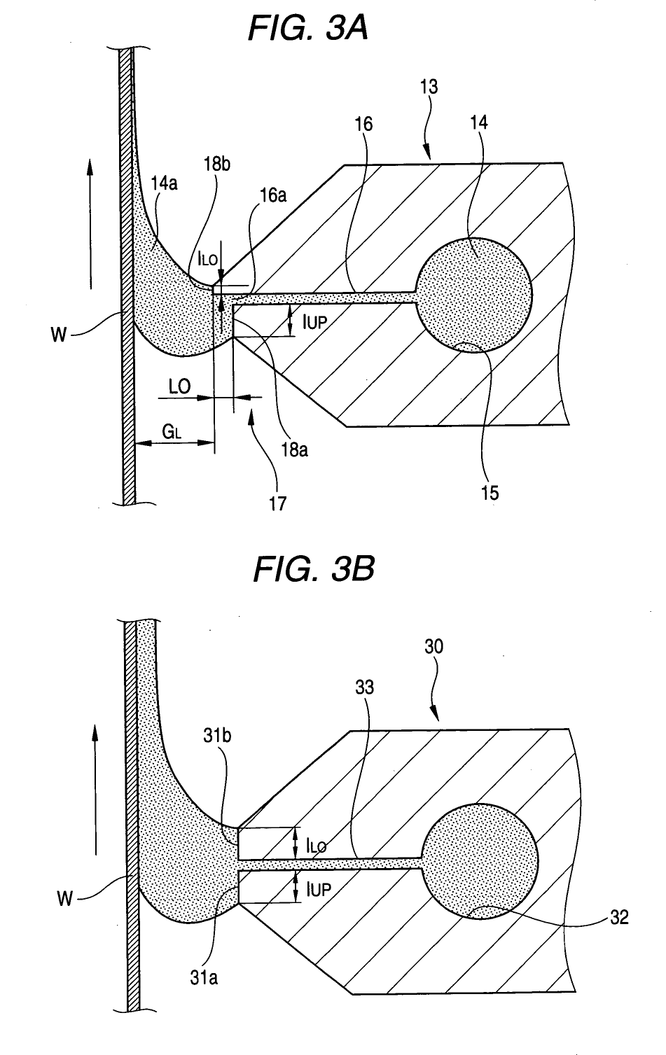

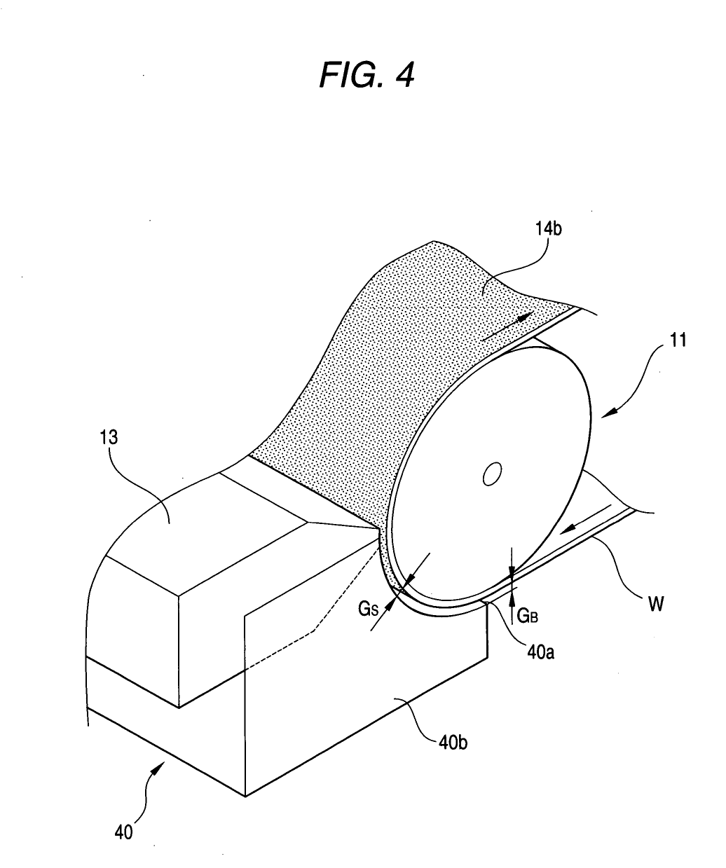

FIG. 3 illustrates a cross-sectional shape of the slot die 13 in comparison with that of a conventional one, and in the figure, (A) illustrates the slot die 13 of the present invention, and (B) illustrates a conventional slot die 30. In the conventional slot die 30, an upstream-side lip land 3 la and a downstream-side lip land 31b are at the same distance from a web. Note that reference numerals 32 and 33 denote a pocket and a slot, respectively. On the other hand, in the slot die 13 of the present invention, the length I_{LO} of the downstream-side lip land 18b is designed to be short, whereby it is possible to apply a wetting film having a thickness of 20 μm or less with high precision.

A land length I_{UP} of the upstream-side lip land 18a is not particularly limited, but preferably in the range from 500 μm to 1 mm. The land length I_{LO} of the downstream-side lip land 18b is from 30 μm to 100 μm, preferably 30 μm to 80 μm, and more preferably 30 μm to 60 μm. In the case where the land length I_{LO} of the downstream-side lip is less than 30 μm, the edge of the tip lip or the land can be readily broken, likely leading to occurrence of a streak on the coating film. As a result, it is not possible to carry out the application. Also, it is made difficult to set the position of the wetting line on the downstream side, causing a problem that the coating liquid is likely to be spread on the downstream side. The spreading of the coating liquid on the downstream side means occurrence of a nonuniform wetting line, which is conventionally known to lead to a problem that a defect, such as a streak or the like, occurs on a coating surface. On the other hand, in the case where the length I_{LO} of the downstream-side lip is greater than 100 μm, a bead itself cannot be formed, and therefore, it is not possible to apply a thin layer.

Further, an overbite shape is formed such that the downstream-side lip land 18b is positioned closer to the web W than the upstream-side lip land 18a, and therefore, it is possible to reduce the degree of decompression and thereby to form a bead suitable for applying a thin film. The difference between a distance from the downstream-side lip land 18b to the web W and a distance from the upstream-side lip land 18a to the web W (hereinafter, referred to as an “overbite length LO”) is preferably 30 μm to 120 μm, more preferably 30 μm to 100 μm, and most preferably 30 μm to 80 μm. When the slot die 13 has an overbite shape, a gap GL between the tip lip 17 and the web W refers to a gap between the downstream-side lip land 18b and the web W.

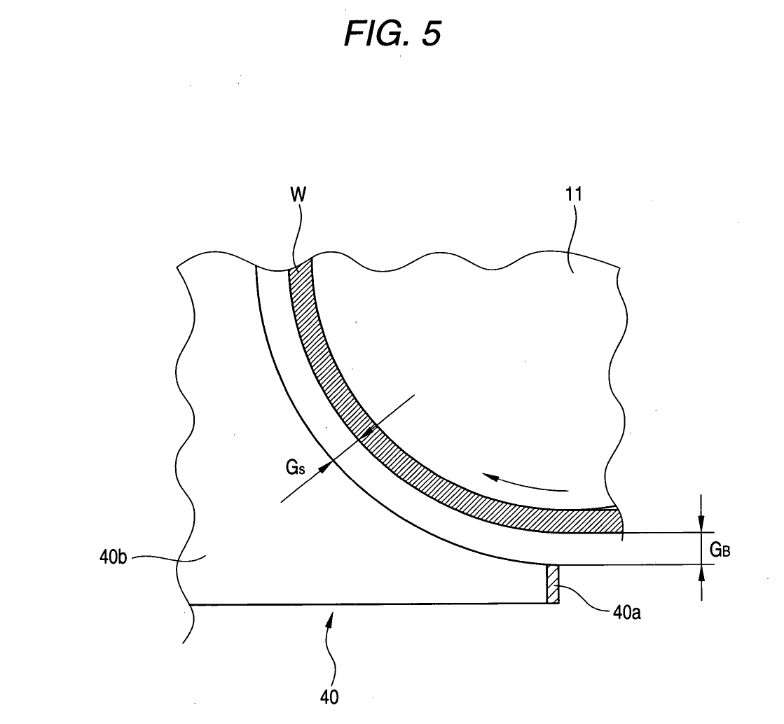

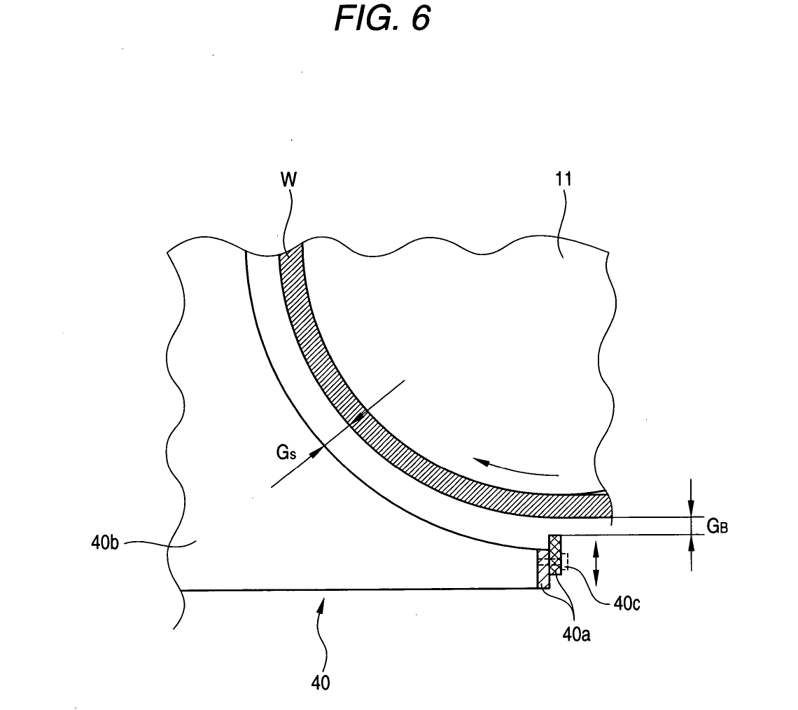

FIG. 4 is a perspective view illustrating a slot die and its peripheral portion in an applying step according to the present invention. A decompression chamber 40 is provided out of contact with the web W and on a side opposite to the traveling direction of the web W so that a sufficient decompression adjustment can be performed with respect to the bead 14a. The decompression chamber 40 includes a back plate 40a and a side plate 40b which are provided for holding the operating efficiency thereof, and gaps G_{B} and G_{S} are present between the back plate 40a and the web W and between the side plate 40b and the web W, respectively. FIGS. 5 and 6 are cross-sectional views illustrating the decompression chamber 40 and the web W which are close to each other. The side plate and the back plate may be integrated with the chamber as illustrated in FIG. 5 or may be attached to the chamber by a screw 40c or the like so that the gap can be changed as appropriate, as illustrated in FIG. 6. In any structure, the actual spaces between the back plate 40a and the web W and between the side plate 40b and the web W are defined as gaps G_{B} and G_{S}, respectively. In the case where the decompression chamber 40 is provided below the web W and the slot die 13 as illustrated in FIG. 4, a gap G_{B} between the back plate 40a of the decompression chamber 40 and the web W denotes a gap between the top end of the back plate 40a and the web W.

The gap G_{B} between the back plate 40a and the web W is preferably greater than a gap G_{L} between the tip lip 17 of the slot die 13 and the web W, so that variations in degree of decompression in the vicinity of the bead, which are caused by the eccentricity of the backup roll 11, can be suppressed. For example, when the gap G_{L} between the tip lip 17 of the slot die 13 and the web W is 30 μm to 100 μm, the gap G_{B} between the back plate 40a and the web W is preferably 100 μm to 500 μm.

(Materials and Precision)

The longer the length in the web moving direction of the tip lip on the web traveling direction side, the more significant the disadvantage for formation of the bead. If this length varies between any points in the width direction of the slot die, the bead is rendered unstable even by slight disturbance. Therefore, the variation range of the length in the width direction of the slot die is preferably within 20 μm.

Also, if a material, such as stainless steel or the like, is used as the material for the tip lip of the slot die, the material sags at the stage of die processing, so that even if the length of the slot die tip lip in the moving direction is in the range from 30 to 100 μm, the precision of the tip lip is not satisfied. Accordingly, in order to ensure high processing precision, it is essential to use a superhard material as disclosed by Japanese Patent No. 2817053. Specifically, at least the tip lip of the slot die is preferably composed of a superhard alloy obtained by binding carbide crystal having an average particle size of 5 μm or less. Examples of the superhard alloy include those obtained by binding crystal particles of carbide, such as tungsten carbide or the like (hereinafter, referred to as “WC”), with a binding metal, such as cobalt or the like. Examples of the binding metal further include titanium, tantalum, niobium, and mixed metals thereof The average particle size of the WC crystals is more preferably 3 μm or less.

In order to realize high precision application, the length of the web traveling direction side land of the tip lip and variations in the gap from the web in the width direction of the slot die are important factors. It is desirable to achieve the straightness in a range in which a combination of the two factors, i.e., the variation range of the gap, can be suppressed to some extent. Preferably, the straightness between the tip lip and the backup roll is achieved such that the variation range of the gap in the width direction of the slot die is 5 μm or less.

(Application Speed)

The precision of the backup roll and the tip lip is achieved as described above, and therefore, the coating method preferably used in the present invention provides a highly stable film thickness at the time of high-speed coating. Further, the coating method of the present invention is of a pre-measurement type, and therefore, it is easy to ensure the stable film thickness even at the time of high-speed coating. The coating method of the present invention can apply a low amount of coating liquid for the anti-glare and anti-reflection film of the present invention at high speed to achieve a satisfactorily stable film thickness. Although the coating can be carried out by other coating methods, a dip coating method inevitably vibrates the coating liquid in a liquid tank, readily causing stepwise irregularities. A reverse roll coating method easily causes stepwise irregularities due to the eccentricity or deflection of a roll involved in the coating. Also, these coating methods are of a post-measurement type, and therefore, it is difficult to ensure a stable film thickness. It is preferable to carry out coating at 25 m/min or more in terms of productivity to use the production method of the present invention.

(Wet Coating Amount)

When the anti-glare layer is formed, it is preferable to apply the coating liquid onto a transparent suppport directly or via another layer to a wet coating thickness ranging from 6 to 30 μm, more preferably from 3 to 20 μm, from the viewpoint of prevention of uneven drying. Also, when the low refractive index layer is formed, it is preferable to apply a coating composition onto the anti-glare layer directly or via another layer to a wet coating thickness ranging from 1 to 10 μm, more preferably from 2 to 5 μm.

(Drying)

The anti-glare layer and the low refractive index layer are applied onto the transparent suppport directly or via another layer, and thereafter, they are transferred in the form of a web to a zone heated for drying a solvent. In this case, it is preferable that the temperature in the drying zone be 25° C. to 140° C., the temperature in the first half of the drying zone is relatively low, and the temperature in the second half is relatively high. However, the temperature is preferably less than or equal to a temperature at which a component(s) other than a solvent contained in a coating composition for each layer starts volatilization. For example, some commercially-available photoradical generators used in combination with ultraviolet curable resin volatilize by about several tens of percent within several minutes in warm air of 120° C. Also, some monofunctional and bifunctional acrylate monomers start volatilization in warm air of 100° C. In such a case, the temperature at which a component(s) other than a solvent contained in a coating composition for each layer starts volatilization or a temperature less than that is preferable as described above.

Also, in order to prevent uneven drying, after applying the coating composition for each layer onto the transparent suppport, the drying air is preferably blown onto the coating film surface at a speed in the range of 0.1 to 2 m/sec when the solid content concentration of the coating composition is 1 to 50%.

Also, it is preferable that after the coating composition for each layer is applied onto the transparent suppport, the difference in temperature in the drying zone between the transparent suppport and a transfer roll in contact with a surface of the base material which is opposite to the coated surface of the transparent suppport, be 0° C. to 20° C., because it is possible to prevent uneven drying from occurring due to uneven heat transfer on the transfer roll.

(Curing)

After the solvent drying zone, the web is passed through a zone for curing each coating film by means of at least either ionizing radiation or heat, to cure the coating film. For example, if the coating film is ultraviolet curable, an ultraviolet lamp is preferably used to irradiate each layer with ultraviolet at an irradiation does of 10 mJ/cm² to 1000 J/cm². At this time, the distribution of the irradiation dose from end to end of the web in the width direction of the web is preferably 50 to 100%, more preferably 80 to 100%, with respect to the maximum irradiation dose in the center. When it is necessary to purge nitrogen gas or the like to reduce the oxygen concentration for the purpose of accelerating surface curing, the oxygen concentration is preferably 0.01 volume % to 5 volume %, and the oxygen concentration in the width direction distribution is preferably 2 volume % or less.

Also, in the case where the curing rate (100—residual functional group content) of the anti-glare layer is a value less than 100%, when the low refractive index layer of the present invention is provided thereon and is cured by means of at least either ionizing radiation or heat, the curing rate of the anti-glare layer located therebelow is preferably increased before providing the low refractive index layer, improving the adhesion ability between the anti-glare layer and the low refractive index layer.

The anti-glare and anti-reflection film of the present invention which is produced in the above-described manner can be used to form a polarizing plate which can be used in a liquid crystal display device. In this case, the plate is provided on one side with an adhesion layer or the like, and is disposed on an outermost surface of a display. The anti-glare and anti-reflection film of the present invention is preferably used as one of two protection films for sandwiching a polarizing film of the polarizing plate.

The anti-glare and anti-reflection film of the present invention also serves as a protection film, and therefore, it is possible to reduce the production cost of the polarizing plate. Also, by using the anti-glare and anti-reflection film of the present invention as the outermost layer, it is made possible to prevent reflection of external light, for example, thereby providing the polarizing plate with satisfactory abrasion resistance and a stain-proof property.

When the polarizing plate is formed using the anti-glare and anti-reflection film of the present invention as one of two surface protection films of the polarizing film, the surface of the transparent support of the anti-glare and anti-reflection film which is opposite to the anti-reflection structure side, i.e., the surface which is to be bonded to the polarizing film, is preferably hydrophilized to improve the adhesion ability of the adhesive surface.

(Saponification Treatment)

(1) Method of Dipping in Alkali Liquid

A method of dipping the anti-glare and anti-reflection film into alkali liquid under appropriate conditions, and performing saponification treatment on all portions of the entire surface of the film which are reactive with alkali, is provided. This method is preferable in terms of cost because no specialized equipment is required. The alkali liquid is preferably an aqueous solution of sodium hydroxide. A preferable concentration thereof is 0.5 to 3 mol/L, and particularly preferably 1 to 2 mol/L. A preferable temperature of the alkali liquid is 30 to 75° C., and particularly preferably 40 to 60° C.

The combination of the above-mentioned conditions of saponification is preferably a combination of relatively moderate conditions, and can be set, depending on the material and structure of the anti-glare and anti-reflection film and a target contact angle.

It is preferable that after the dip in the alkali liquid, the film be sufficiently washed in water or dipped in a dilute acid to neutralize an alkali component(s), in order not to leave the alkali component(s) therein.

The saponification treatment hydrophilizes the surface of the transparent support which is opposite to the surface on which the anti-glare layer or anti-reflection layer is present. The protection film for a polarizing plate is used with the hydrophilized surface of the transparent support being bonded to the polarizing film.

The hydrophilized surface is effective to improve the adhesion ability to an adhesive layer containing polyvinyl alcohol as a major component.

If the surface of the transparent support which is opposite to the surface on which the anti-glare layer or low refractive index layer is present has a lower contact angle against water, the saponification treatment is more preferable in terms of the adhesion ability to the polarizing film. In the dipping method, however, both the surface on which the anti-glare layer or low refractive index layer is present and the inside of the support are damaged by alkali, and therefore, it is important to minimize the reaction conditions. When the contact angle against water of the opposite surface of the transparent support is used as an indicator of damage on each layer by alkali, the angle is preferably 10 degrees to 50 degrees, more preferably 30 degrees to 50 degrees, and even more preferably 40 degrees to 50 degrees, particularly if the transparent support is triacetylcellulose. It is preferable that the contact angle be within the above range, because the adhesion ability to the polarizing film is satisfactory, and the damage on the anti-reflection film is sufficiently small so that the physical hardness is maintained.

(2) Method of Applying Alkali Liquid

As a means for avoiding damage on each film in the above dipping method, an alkali liquid applying method is preferably used for applying an alkali liquid only onto the surface opposite to the surface on which the anti-glare layer or anti-reflection film is present, and performing heating, washing in water, and drying, under appropriate conditions. Note that the application in this case means that an alkali liquid is brought into contact only with the surface which is to be subjected to saponification, and may be carried out not only by application but also by, for example, spraying, or contacting with a belt soaked with a liquid. Employing this method additionally requires equipment and a step of applying the alkali liquid, and therefore, the method is inferior to the dipping method in (1) above in terms of cost. However, the alkali liquid is brought into contact only with the surface which is to be subjected to saponification treatment, and therefore, it is possible to dispose, on the opposite surface, a layer composed of a material weak to the alkali liquid. For example, a deposited film or a sol-gel film is affected variously by the alkali liquid (e.g., erosion, dissolution, detachment, etc.), and therefore, is not preferable for the dipping method. In this application method, such a film can be used without any problem because the film does not contact with the liquid.

Any of the saponification methods described above in (1) or (2) can be carried out after a roll-shaped support is wound out and each layer is formed, and therefore, may be additionally carried out with a series of operations after the above-described step of producing the anti-glare and anti-reflection film. In addition, by successively performing the step of bonding to the polarizing plate made of a support similarly wound out, it is possible to form polarizing plates more efficiently than a similar operation is performed on separate sheets.

(3) Method of Saponification by Protecting Anti-Glare Layer or Anti-Reflection Layer With Laminate Film

Similar to the above (2), if at least either the anti-glare layer or the low refractive index layer lacks resistance to the alkali liquid, after layers up to a final layer are formed, a laminate film is bonded to a surface of the formed final layer on which the final layer is formed, and dipping in the alkali liquid is carried out to hydrophilize only a triacetylcellulose surface which is opposite to the surface on which the final layer is formed. Thereafter, the laminate film can be detached. Also in this method, hydrophilizing treatment sufficient with respect to a polarizing plate protection film can be performed only on the surface of the triacetylcellulose film which is opposite to the surface on which the final layer is formed, without damage on the anti-glare layer or low refractive index layer. Although the laminate film turns into a waste product, this method is advantageous over the method described above in (2) in that a special device for applying the alkali liquid is not required.

(4) Method of Dipping in Alkali Liquid After Layers Up to Anti-Glare Layer are Formed

Layers up to the anti-glare layer are resistant to the alkali liquid, but in the case where the low refractive index layer lacks resistance to the alkali liquid, after layers up to the anti-glare layer are formed, the layers are dipped into the alkali liquid to hydrophilize opposite sides of the layers. Thereafter, the low refractive index layer can be formed on the anti-glare layer. Although the production process becomes complicated, this method is advantageous in that the interlayer adhesion ability between the anti-glare layer and the low refractive index layer is enhanced particularly in the case where the low refractive index layer contains a hydrophilic group, such as a fluorine-containing sol-gel film or the like.

(5) Method of Forming Anti-Glare Layer or Anti-Reflection Layer on Pre-Saponified Triacetylcellulose Film

A triacetylcellulose film may be previously saponified by dipping it in alkali liquid, and an anti-glare layer or a low refractive index layer may be formed on one surface thereof directly or via another layer. In the case of carrying out saponification by dipping in alkali liquid, the interlayer adhesion ability between the anti-glare layer or the other layer and the triacetylcellulose surface hydrophilized by the saponification may be reduced. In such a case, corona discharge treatment or glow discharge treatment is performed only on the surface on which the anti-glare layer or the other layer is to be formed, so that the anti-glare layer or the other layer can be formed after the hydrophilized surface is removed. Also, if the anti-glare layer or the other layer contains a hydrophilic group, the interlayer adhesion ability may be satisfactory.

Hereinafter, a polarizing plate employing the anti-glare and anti-reflection film of the present invention and a liquid crystal display device employing the polarizing plate will be described.

(Polarizing Plate)

A preferable polarizing plate of the present invention has the anti-glare and anti-reflection film of the present invention as at least one protection film of a polarizing film (a protection film for a polarizing plate). As described above, in the protection films for the polarizing plate, a surface of a transparent support which is opposite to a surface thereof on which the anti-glare layer or the anti-reflection layer is formed, i.e., a surface which is to be bonded to the polarizing film, is present preferably has a contact angle against water of 10 degrees to 50 degrees.

By using the anti-glare and anti-reflection film of the present invention as a protection film for the polarizing plate, it is possible to produce a polarizing plate with a anti-glare and anti-reflection function which has excellent physical hardness and light resistance, leading to a significant reduction in cost and a reduction in thickness of a display device.

Also, by producing a polarizing plate which employs the anti-glare and anti-reflection film of the present invention as one protection film for the polarizing plate and an optically anisotropic optical compensation film which will be described below as the other protection film of the polarizing film, it is possible to produce a polarizing plate which improves the visibility and contrast of a liquid crystal display device in a bright room, and significantly the viewing angles in vertical and horizontal directions.

(Optical Compensation Film)

By providing the polarizing plate with an optical compensation film (a retardation layer), it is possible to improve viewing angle characteristics of a liquid crystal display screen.

As the optical compensation film, a known film can be used, but it is preferable, in terms of widening the viewing angle, to use an optical compensation film characterized by including an optically anisotropic layer composed of a compound having a discotic structural unit, in which the angle made between the discotic compound and a transparent support varies depending on a distance from the transparent support.

The angle is preferably increased with an increase in the distance from the transparent support-side surface of the optically anisotropic layer composed of the discotic compound.

When the optical compensation film is used as a protection film of the polarizing film, a surface of the optical compensation film which is to be bonded to the polarizing film is preferably subjected to saponification treatment which is preferably carried out in the above-described manner.

(Polarizing Film)

As the polarizing film, a known polarizing film, or a polarizing film cut out from a long polarizing film having an absorption axis neither parallel nor vertical to a longitudinal direction may be used. The long polarizing film having an absorption axis neither parallel nor vertical to the longitudinal direction is produced with the following method.

Specifically, a polarizing film is obtained by holding opposite ends of a polymer film which is continuously fed, with a holding means, and drawing it by providing tension thereto, in accordance with a drawing method in which the film is drawn by a factor of 1.1 to 20.0 at least in a film width direction, the difference in moving speed in the longitudinal direction between a holding device at opposite film ends is within 3%, and the film traveling direction is bent, with the opposite film ends being held, so that an angle made between the film traveling direction at the end of the step for holding the opposite film ends and the substantial film drawing direction is tilted by 20 to 70°. Particularly, the angle inclined by 45° is preferable from the viewpoint of productivity.

The method for drawing a polymer film is described in detail in paragraphs 0020 to 0030 of Japanese Unexamined Patent Publication No. 2002-86554.

(Liquid Crystal Display Device)

The anti-glare and anti-reflection film of the present invention can be applied to image display devices, such as a liquid crystal display device (LCD), a plasma display panel (PDP), an electroluminescence display (ELD), and a cathode-ray tube display device (CRT). The anti-glare and anti-reflection film of the present invention has a transparent support, and therefore, the transparent support side thereof is bonded to the image display screen of an image display device.

When the anti-glare and anti-reflection film of the present invention is used as one surface protection film of a polarizing film, the light scattering film or the anti-reflection film can be preferably used in a transmissive, reflective, or transflective liquid crystal display device of twisted nematic (TN) mode, super twisted nematic (STN) mode, vertical alignment (VA) mode, in-plane switching (IPS) mode, optically compensated bend cell (OCB) mode, or the like. Particularly, in applications, such as a large-size liquid crystal television and the like, the film can be preferably used the VA, IPS, or OCB mode. In applications, such as small- and medium-size low-definition display devices, it can be preferably used in the TN or STN mode. In applications, such as a large-size liquid crystal television and the like, the film can be particularly preferably used in the one whose display screen diagonal is 20 inches or more. The anti-glare and anti-reflection film of the present invention has substantially no internal haze, and thus, in the case of a 20-inch screen having a definition level exceeding the XGA level (1024×768 in the case of a display device having a 3:4 aspect ratio), glaring exceeds a tolerance level. Therefore, the film is not preferable when glaring is a main concern. Also, glaring occurs depending on the relationship between a pixel size and surface roughness of an anti-glaring film on a display surface. Therefore, the film can be preferably used for a display device having a definition level of UXGA (1600×1200 in the case of a display device having a 3:4 aspect ratio) or less if the display device is of a 30-inch type, and a display device having a definition level of QXGA (2048×1536 in the case of a display device having a 3:4 aspect ratio) or less if the display device is of a 40-inch type.

A liquid crystal cell of the VA mode include: (1) a liquid crystal cell of the VA mode in a narrow sense (described in Japanese Unexamined Patent Publication No. H02-176625) in which rod-like liquid crystal molecules are substantially vertically aligned in the absence of applied voltage, and are substantially horizontally aligned in the presence of applied voltage; (2) a liquid crystal cell (of the MVA mode) in which the VA mode is modified to be multi-domain type so as to enlarge a viewing angle (described in SID97, Digest of Tech. Papers (proceedings), 28(1997), 845); (3) a liquid crystal cell of a mode (n-ASM mode) in which rod-like liquid crystalline molecules are substantially vertically aligned in the absence of applied voltage, and are in twisted multi-domain alignment in the presence of applied voltage (described in Digest of tech. Papers 58-59 (1998), Liquid crystal forum of Japan; and (4) a liquid crystal cell of SURVAIVAL mode (presented at LCD international 98).

The liquid crystal cell of the OCB mode is a liquid crystal display device using a liquid crystal cell of bend alignment mode in which rod-like liquid crystalline molecules are substantially reversely (symmetrically) aligned in upper and lower parts of the liquid crystal cell, and is disclosed in U.S. Pat. Nos. 4,583,825 and 5,410,422. Since the rod-like liquid crystal molecules are symmetrically aligned in upper and lower parts of the liquid crystal cell, the liquid crystal cell of the bend alignment mode has a self-optical compensatory function. Accordingly, this liquid crystal mode is referred to as OCB (Optically Compensatory Bend) liquid crystal mode. The liquid crystal display device of the bend alignment mode has an advantage of quick response speed.

In a liquid crystal cell of the ECB mode, rod-like liquid crystalline molecules are substantially horizontally aligned in the absence of applied voltage, and the liquid crystal cell of this mode is most widely used as a color TFT liquid crystal display device, and is described in a number of publications, e.g., “EL, PDP, and LCD displays”, published by Toray Research Center, Inc. (2001).

### EXAMPLES

Details of the present invention will be described by way of the following examples. The present invention is not limited to these examples. Note that “parts” and “%” are by mass unless otherwise specified.

(Synthesis of Perfluoroolefin Copolymer (1))

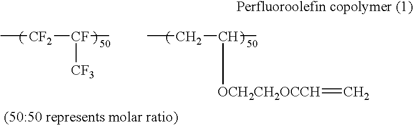

40 ml of ethyl acetate, 14.7 g of hydroxyethyl vinyl ether, and 0.55 g of dilauroyl peroxide were mixed in an autoclave with a stainless agitator having a capacity of 100 ml, the system was deaerated and the inside space of the system was replaced with nitrogen gas. Further, 25 g of hexafluoropropylene (HFP) was introduced into the autoclave, which was in turn heated to 65° C. The pressure of the autoclave was 0.53 MPa (5.4 kg/cm²) at the time when the temperature in the autoclave reached 65° C. The temperature was maintained and a chemical reaction was continuously carried out for 8 hours, and when the pressure reached 0.31 MPa (3.2 kg/cm²), the heating was stopped, and the autoclave was left to be cooled. When the internal temperature decreased to room temperature, non-reacted monomers were removed, and the autoclave was opened to remove the reaction liquid. The obtained reaction liquid was introduced into a large excess of hexane, and the solvent thereof was removed by decantation to obtain a precipitated polymer. The polymer was dissolved in a small amount of ethyl acetate, and was reprecipitated twice to completely remove residual monomers from hexane. After drying, 28 g of polymer was obtained. Next, 20 g of the polymer was dissolved in 100 ml of N,N-dimethylacetamide, and after 11.4 g of acrylic acid chloride was dripped thereto while the mixture is ice-cooled , the reaction liquid was stirred at room temperature for 10 hours. Ethyl acetate was added to the reaction liquid, followed by washing with water, and after extracting an organic layer, was condensed, and the obtained polymer was reprecipitated in hexane to obtain 19 g of perfluoroolefin copolymer (1). The refractive index of the obtained polymer was 1.421.

(Preparation of Sol Liquid a)

In a reaction vessel equipped with an agitator and a reflux condenser, 120 parts of methyl ethyl ketone, 100 parts of acroyloxypropyl trimethoxysilane (KBM-5103, manufactured by Shin-etsu Chemical Co., Ltd.), and 3 parts of diisopropoxy aluminium ethylacetoacetate were added and mixed, and thereafter, 30 parts of ion exchanged water were added thereto. The mixture was allowed to react at 60° C. for 4 hours, followed by cooling to room temperature to obtain a sol liquid a. The mass-average molecular weight was 1600, and among oligomer or polymer components, components having a molecular weight of 1000 to 20000 constitute 100%. Also, according to gas chromatography analysis, it was found that there was no remaining acryloyloxypropyltrimethoxysilane raw material.

(Preparation of Coating liquid A for Anti-Glare Layer)

31 g of a mixture of pentaerythritol triacrylate and pentaerythritol tetraacrylate (PET-30, manufactured by Nippon Kayaku Co.) was diluted with 38 g of methyl isobutyl ketone. Further, 1.5 g of a polymerization initiator (IRGACURE 184, manufactured by Ciba Specialty Chemicals) was added thereto, followed by mixing and stirring. Following this, 0.04 g of fluorine-based surface modifier (FP-149) and 6.2 g of silane coupling agent (KBM-5103, manufactured by Shin-etsu Chemical Co., Ltd.) were added thereto. The resultant solution was applied and ultraviolet-cured to obtain a coating film having a refractive index of 1.520.

Finally, a final liquid was obtained by adding, to the resultant solution, 21.0 g of 30% cyclohexanone dispersion liquid of a crosslinkable poly(acryl-styrene) particle (copolymerization composition ratio: 45/55, refractive index: 1.530) having an average particle size of 3.5 μm, and was dispersed at 10000 rpm for 20 minutes using a Polytron disperser.

The above liquid mixture was filtered through a 30-μm pore size filter composed of polypropylene to prepare a coating liquid A for an anti-glare layer.

(Preparation of Coating liquid B for Anti-Glare Layer)

A coating liquid B for an anti-glare layer was prepared in the same manner as that of the coating liquid A for an anti-glare layer, except that the copolymerization composition ratio of the crosslinkable poly(acryl-styrene) particle (copolymerization composition ratio: 45/55, refractive index: 1.530) having an average particle size of 3.5 μm was changed to 50/50 (refractive index: 1.540).

(Preparation of Coating Liquid C for Anti-Glare Layer)

A coating liquid C for anti-glare layer was prepared in the same manner as that of the coating liquid A for an anti-glare layer, except that the crosslinkable poly(acryl-styrene) particle (copolymerization composition ratio: 45/55, refractive index: 1.530) having an average particle size of 3.5 μm was changed to a crosslinkable poly(methylmethacrylate) particle (a crosslinking agent containing 10% ethylene glycol dimethacrylate, refractive index: 1.492) having an average particle size of 3.0 μm, and the amount of 30% cyclohexanone dispersion liquid to be added was changed to 14.0 g.

(Preparation of Coating Liquid D for Anti-Glare Layer)

A coating liquid D for an anti-glare layer was prepared in the same manner as that of the coating liquid A for an anti-glare layer, except that the crosslinkable poly(acryl-styrene) particle (copolymerization composition ratio: 45/55, refractive index: 1.530) having an average particle size of 3.5 μm was changed to a crosslinkable polystyrene particle (refractive index: 1.607).

(Preparation of Coating Liquid E for Anti-Glare Layer)

A coating liquid E for an anti-glare layer was prepared in the same manner as that of the coating liquid A for an anti-glare layer, except that the copolymerization composition ratio of the crosslinkable poly(acryl-styrene) particle (copolymerization composition ratio: 45/55, refractive index: 1.530) having an average particle size of 3.5 μm was changed to 50/50 (refractive index: 1.540), and the amount of 30% cyclohexanone dispersion liquid to be added was changed to 39.0 g.

(Preparation of Coating Liquid F for Anti-Glare Layer)

A coating liquid F for an anti-glare layer was prepared in the same manner as that of the coating liquid A for an anti-glare layer, except that the copolymerization composition ratio of the crosslinkable poly(acryl-styrene) particles (copolymerization composition ratio: 45/55, refractive index: 1.530) having an average particle size of 3.5 μm was changed to 50/50 (refractive index: 1.540), and the amount of 30% cyclohexanone dispersion liquid to be added was changed to 26.0 g.

(Preparation of Coating Liquid G for Antiglare Layer)

A coating liquid G for ant-glare layer was prepared in the same manner as for coating liquid A for antiglare layer, except that the aforementioned silane coupling agent KBM-5103 was changed to an oligomer as a commercial-available silane coupling agent (X-40-2671G, a product of Shin-Etsu Chemical Co., Ltd.) which is in a range of the compound represented by the formula (2).

(Preparation of Coating Liquid A for Low Refractive Index Layer)

13 g of a thermal crosslinkable fluorinated polymer (JTA113, manufactured by JSR Corp.; solid content concentration: 6%) having a refractive index of 1.44 and containing polysiloxane and a hydroxy group, 1.3 g of colloidal silica dispersion liquid (MEK-ST-L (trade name), manufactured by Nissan Chemical Industries, Ltd.; average particle size: 45 nm, solid content concentration: 30%), 0.6 g of the above sol liquid, 5 g of methyl ethyl ketone, and 0.6 g of cyclohexanone were added together, followed by stirring. Thereafter, the resultant solution was filtered through a 1-μm pore size filter composed of polypropylene to prepare a coating liquid A for a low refractive index layer. The layer formed of the coating liquid had a refractive index of 1.45:

(Preparation of Coating Liquid B for Low Refractive Index Layer)

A coating liquid B for a low refractive index layer was prepared in the same manner (the same added amounts) as that of the coating liquid A for an anti-glare layer, except that 1.95 g of hollow silica sol (refractive index: 1.31, average particle size: 60 nm, solid content concentration: 20%) was used instead of the silica sol of the coating liquid A for a low refractive index layer. The layer formed of the coating liquid had a refractive index of 1.39.

(Preparation of Coating Liquid C for Low Refractive Index Layer)

15.2 g of perfluoroolefin copolymer (1), 1.4 g of silica sol (silica, different in particle size from MEK-ST, manufactured by Nissan Chemical Industries, Ltd.; average particle size: 45 nm, solid content concentration: 30%), 0.3 g of reactive silicone (X-22-164B (trade name), manufactured by Shin-etsu Chemical Co., Ltd.), 7.3 g of sol liquid a, 0.76 g of photopolymerization initiator (IRGACURE 907 (trade name), manufactured by Ciba Specialty Chemicals), 301 g of methyl ethyl ketone, and 9.0 g of cyclohexanone were added together, followed by stirring. Thereafter, the resultant solution was filtered through a 5-μm pore size filter composed of polypropylene to prepare a coating liquid C for a low refractive index layer. The layer formed of the coating liquid had a refractive index of 1.44.

Example 1

(1) Application of Anti-Glare Layers

A triacetylcellulose film having a thickness of 80 μm (TAC-TD80U, manufactured by Fuji Photo Film Co., Ltd.) was wound off the roll, and the coating liquid A for an anti-glare layer was applied by a die coating method specified by the below-described device configuration and coating condition, followed by drying at 30° C. for 15 seconds and at 90° C. for 20 seconds. Thereafter, the applied layer was cured by irradiating with ultraviolet light using a 160-W/cm air-cooled metal halide lamp (manufactured by EYEGRAPHICS CO., LTD.) at a dose of 90 mJ/cm² in an atmosphere purged with nitrogen to form a 6 μm-thick anti-glare layer having an anti-glare property. The coated film was wound.

Basic conditions: the slot die 13 had an upstream-side lip land length I_{UP} of 0.5 mm, a downstream-side lip land length I_{LO} of 50 μm, and a 50 mm-long slot 16 with an opening portion whose length in the web moving direction is 150 μm. The gap between the upstream-side lip land 18a and the web W was set to be 50 μm longer than the gap between the downstream-side lip land 18b and the web W (hereinafter, described as “overbite length 50 μm”), and the gap G_{L} between the downstream-side lip land 18b and the web W was set to 50 μm. Also, the gap G_{S} between the side plate 40b of the decompression chamber 40 and the web W and the gap G_{B} between the back plate 40a and the W were both set to 200 μm. The anti-glare layer and the low refractive index layer were applied in accordance with the liquid property of their respective coating liquids (anti-glare layer: application speed=50 m/min, wet application amount=17 ml/m², low refractive index layer: application speed=40 m/min, wet application amount=5 ml/m²). Note that the width of application was 1300 mm, and the effective width was 1280 mm.

(2) Application of Low Refractive Index Layer

The triacetylcellulose film on which the anti-glare layer was provided by applying the coating liquid A for an anti-glare layer was rewound off, and the coating liquid A for a low refractive index layer was applied thereon under the above basic conditions. The film was dried at 120° C. for 150 seconds, and thereafter, further dried at 140° C. for 8 minutes. The applied layer was then cured by irradiating with ultraviolet light from a 240-W/cm air-cooled metal halide lamp (manufactured by EYEGRAPHICS CO., LTD.) at a dose of 900 mJ/cm² in an atmosphere purged with nitrogen, where the oxygen concentration was 0.1 voume %, to form a 100 nm-thick low refractive index layer. The coated film was wound.

(3) Saponification Treatment of Anti-Glare and Anti-Reflection Film

After forming the low refractive index layer, the following treatment was performed with respect to the above sample.

A 1.5 mol/l aqueous solution of sodium hydroxide was prepared and kept at 55° C. A 0.01 mol/l diluted aqueous solution of sulfuric acid was prepared and kept at 35°. The prepared anti-glare and anti-reflection film was dipped in the aqueous solution of sodium hydroxide for 2 minutes, and then dipped in water so that the aqueous solution of sodium hydroxide was thoroughly washed away. Next, the film was dipped in the above dilute aqueous solution of sulfuric acid for 1 minute, and then dipped in water so that the dilute aqueous solution of sulfuric acid was thoroughly washed away. Finally, the sample was thoroughly dried at 120° C.

In this manner, a saponified anti-glare and anti-reflection film was produced. This is referred to as “Example 1-1”.

Anti-glare layers were formed in the same manner as in Example 1-1, except that the coating liquid A for an anti-glare layer was changed to the coating liquids B and C for an anti-glare layer. Further, low refractive index layers were applied and subjected to saponification treatment in the same manner as in Example 1-1. The one coated with the coating liquid B for an anti-glare layer is referred to as “Example 1-2”, and the one coated with the coating liquid C for an anti-glare layer is referred to as “Example 1-3”.

Also, anti-glare layers were formed in the same manner as in Example 1-1, except that the coating liquid A for an anti-glare layer was changed to the coating liquids E and F for an anti-glare layer, and the wet coating amount was set to 21 ml/m². Further, low refractive index layers were applied and were subjected to saponification treatment in the same manner as in Example 1-1. The one coated with the coating liquid E for an anti-glare layer is referred to as “Example 1-4”, and the one coated with the coating liquid F for an anti-glare layer is referred to as “Example 1-5”.

Also, an anti-glare layer was formed in the same manner as in Example 1-1, except that the coating liquid A for an anti-glare layer was changed to the coating liquid D for an anti-glare layer. Further, a low refractive index layer was applied and was subjected to saponification treatment in the same manner as in Example 1-1. The one coated with the coating liquid D for an anti-glare layer is referred to as “Comparative Example 1-1”.

(Evaluation of Anti-Glare and Anti-Reflection Films)

The following evaluation was performed for the obtained films. The results are shown in Table 1.

(1) Average Reflectance

Back surfaces of films were rendered rough by sandpaper, and thereafter, were treated with black ink so as to eliminate back surface reflection. In this state, a spectrophotometer (manufactured by JASCO Corporation) was used to measure the specular spectral reflectances of the top surfaces at an incident angle of 5° in a wavelength region of 380 nm to 780 nm. The results are based on the arithmetic mean value of specular reflectances between 450 to 650 nm.

(2) Haze

The obtained films were measured for the total haze (H), internal haze (Hi), and surface haze (Hs) in accordance with the following measurement:

(i) The obtained films were measured for the total haze value (H) in accordance with JIS-K7136;

(ii) Sellotape (registered trademark) (produced by Nichiban Co., Ltd.) was stuck to the low refractive index layer-side surface of the obtained film, the haze was measured with the internal haze removed, and the internal haze (Hi) of the film was calculated by subtraction of the separately measured haze of the sellotape (registered trademark); and

(iii) a value calculated by subtracting the internal haze (Hi) calculated in the above (ii) from the total haze (H) measured in the above (i) was obtained as the surface haze (Hs) of the film.

(3) Central Line Average Roughness

The obtained films were measured for the center line average roughness Ra in accordance with JIS-B0601.

(4) Anti-Glare Property

Light of an uncovered fluorescent lamp (8000 cd/m²) without a louver was cast onto the obtained films from an angle of 45 degrees, and the blurring degree of the reflected image observed from an angle of −45 degrees was visually evaluated in accordance with the following criteria.

The outline of the fluorescent lamp is not recognizable: ⊚

The outline of the fluorescent lamp is slightly recognizable: ◯

The fluorescent lamp is blurred, but the outline thereof is recognizable: Δ

The fluorescent lamp is substantially not blurred: X

TABLE 1

| | Average | Internal | Surface | Total | | |
|---|---|---|---|---|---|---|
| | reflectance | haze | haze | haze | | Anti-glare |
| Sample NO. | (%) | (%) | (%) | (%) | Ra (μm) | property |
| Example 1-1 | 1.6 | 1.5 | 9.1 | 10.0 | 0.21 | ◯ |
| Example 1-2 | 1.6 | 2.3 | 9.2 | 10.9 | 0.19 | ⊚ |
| Example 1-3 | 1.6 | 4.2 | 9.0 | 12.6 | 0.20 | ⊚ |
| Example 1-4 | 1.8 | 28.0 | 7.6 | 34.6 | 0.17 | ⊚ |
| Example 1-5 | 1.7 | 23.1 | 8.9 | 31.0 | 0.16 | ⊚ |
| Comparative | 1.6 | 38.5 | 8.5 | 36.4 | 0.20 | ⊚ |
| Example 1-1 | | | | | | |

Also, an anti-glare and anti-reflection film was formed in the same manner as in Example 1-1, except that the coating liquid A for a low refractive index layer was replaced with the coating liquid B for a low refractive index layer. In this case, the average reflectance was improved to 1.2%.

Also, an anti-glare and anti-reflection film was formed in the same manner as in Example 1-1, except that the coating liquid A for a low refractive index layer was replaced with the coating liquid C for a low refractive index layer and the drying conditions after application were changed to 100° for 2 minutes. In this case, the average reflectance was improved to 1.5%. Also, because the coating liquid C for a low refractive index layer does not require thermal curing, the time required for drying was reduced. Moreover, an antiglare, antireflection film was produced in the same manner except that the coating liquid A for antiglare layer in Example 1-1 was replaced with the coating liquid G for antiglare layer, resulting in a film with high productivity and excelling in scratch resistance.

### Example 2

(Production of Polarizing Plate)

A triacetylcellulose film (TAC-TD80U, manufactured by Fuji Photo Film Co., Ltd.) having a thickness of 80 μm was dipped in a 1.5 mol/l aqueous solution of NaOH at 55° C. for 2 minutes, followed by neutralization and washing in water. The triacetylcellulose film and an anti-glare and anti-reflection film produced in accordance with Example 1 (saponified films: Examples 1-1 to 1-5, Comparative Example 1-1) were bonded to protect opposite sides of a polarizer produced by adsorption of iodine to polyvinyl alcohol and drawing, to produce a polarizing plate. Polarizing plates thus produced are referred to as Examples 2-1 to 2-5 and Comparative Examples 2-1.

Also, the above-described saponified triacetylcellulose film was used as a protection film for the opposite sides to produce a polarizing plate, which is referred to as Comparative Example 2-2.

Example 3

(Evaluation of Polarizing Plate)

In accordance with combinations shown in Table 2 below, the polarizing plates produced according to Examples 2-1 to 2-5 and Comparative Examples 2-1 and 2-2 in Example 2 were used in replacement of a portion of a viewing-side polarizing plate which was detached from each liquid crystal television. The resultant display devices were evaluated for the following items. The results are shown in Table 2.

(1) Image Blurring

The word “z,1” (chinise character of “rose”) (in Mincho typeface at a font size of 10 points was displayed in ten successive lines each containing twenty-five letters on white background using LCD panels (all of which are in the VA mode) whose definition level and image size are as shown in the table. In this state, the degree of blurring (image blurring) of the outline of the letter was visually evaluated in accordance with the following criteria, comparing to the case where a polarizing plate without an anti-glare property was used for displaying in the same manner.

Desirable with no bothering blurring:

[symbol]

Relatively desirable with almost no bothering blurring: ◯

Slightly bothered by blurring: Δ

Undesirable with noticeable blurring: X

(2) Glaring

A plain solid green background was displayed on the LCD panels whose definition level and image size are as shown in Table 2. In this state, the degree of nonuniform partial expansion/shrinkage of B, G and R pixels as visually viewed (glaring) was evaluated in accordance with the following criteria.

Desirable with no recognizable glaring: ⊚

Relatively desirable with slightly recognizable glaring: ◯

Slightly bothered by glaring: Δ

Undesirable with noticeable glaring: X

(3) Reflection

Light of an uncovered fluorescent lamp (8000 cd/m²) without a louver was cast onto the obtained liquid crystal televisions from an angle of 45 degrees, and the blurring degree of a reflected image of the fluorescent lamp observed from an angle of −45 degrees was visually evaluated in accordance with the following criteria.

The outline of the fluorescent lamp is not recognizable because there is no reflection:

[symbol]

The outline of the fluorescent lamp is slightly recognizable and there is almost no reflection: ◯

The fluorescent lamp is blurred, and slight reflection is observed: Δ

The fluorescent lamp is entirely reflected: X

(4) Front Contrast

The LCD panels (all are in the VA mode) whose definition level and image size are as shown in Table 2 were measured for front contrast in a dark room. The evaluations thereof were carried out in accordance with the following criteria, comparing to the case where front side polarizing plates were replaced with polarizing plates using two smooth-surface TAC films as protection films.

No reduction in contrast:

[symbol]

0 to 2% reduction in contrast: ◯

2 to 10% reduction in contrast: Δ

10% or more reduction in contrast: X

TABLE 2

| | | Panel | Panel | | | | |
|---|---|---|---|---|---|---|---|
| | Polarizing | size | definition | Image | | | Front |
| Sample No. | plate | (in.) | level | blurring | Glaring | Reflection | contrast |
| Example 3-1 | Example 2-1 | 20 | VGA | ⊚ | ◯ | ◯ | ⊚ |
| Example 3-2 | Example 2-2 | 20 | VGA | ⊚ | ⊚ | ⊚ | ⊚ |
| Example 3-3 | Example 2-3 | 20 | VGA | ◯ | ⊚ | ⊚ | ◯ |
| Example 3-4 | Example 2-4 | 20 | VGA | ◯ | ⊚ | ⊚ | Δ |
| Example 3-5 | Example 2-5 | 20 | VGA | ◯ | ⊚ | ⊚ | ◯ |
| Comparative | Comparative | 20 | VGA | Δ | ⊚ | ⊚ | X |
| Example 3-1 | Example 2-1 | | | | | | |
| Comparative | Comparative | 20 | VGA | ⊚ | ⊚ | X | ⊚ |
| Example 3-2 | Example 2-2 | | | | | | |
| Example 3-6 | Example 2-1 | 37 | XGA | ⊚ | ◯ | ◯ | ⊚ |
| Example 3-7 | Example 2-1 | 37 | XGA | ⊚ | ⊚ | ◯ | ⊚ |
| Example 3-8 | Example 2-2 | 45 | XGA | ⊚ | ⊚ | ⊚ | ⊚ |
| Example 3-9 | Example 2-3 | 45 | XGA | ◯ | ⊚ | ⊚ | ◯ |
| Example 3-10 | Example 2-4 | 45 | XGA | ◯ | ⊚ | ⊚ | Δ |
| Example 3-11 | Example 2-5 | 45 | XGA | ◯ | ⊚ | ⊚ | ◯ |
| Comparative | Comparative | 45 | XGA | Δ | ⊚ | ⊚ | X |
| Example 3-3 | Example 2-1 | | | | | | |
| Comparative | Comparative | 45 | XGA | ⊚ | ⊚ | X | ⊚ |
| Example 3-4 | Example 2-2 | | | | | | |

The following are clear from the results shown in Table 2.

When applied to a liquid crystal television with a screen of 20 inches or more, the anti-glare and anti-reflection film of the present invention can simultaneously achieve a high anti-glare property, improvements against image blurring, glaring, and contrast reduction in a dark room.

### Example 4

A viewing-angle widening film (wide-view film SA 12B, manufactured by Fuji Photo Film Co., Ltd.) was used as both a protection film on the liquid crystal cell side of a viewing-side polarizing plate of a transmissive TN liquid crystal cell and a protection film on the liquid crystal cell side of a backlight-side polarizing plate. The resultant liquid crystal display device achieved a significantly wide viewing angle in vertical and horizontal directions, extremely high visibility, and high image resolution.

(Reference Example)

The anti-glare layer and the low refractive index layer of Example 1-1 were applied using a bar coating method. A No. 10 bar was used for the anti-glare layer, and a No. 2.9 bar was used for the low refractive index layer. In the case of the anti-glare layer, streak-like surface unevenness occurred at a coating speed of 15 m/min or more. In the case of the low refractive index layer, streak-like surface unevenness occurred at a coating speed of 20 m/min or more.

The present invention provides an anti-glare and anti-reflection film which achieves both a high anti-glare property and improvements against image blurring and glaring. The present invention also provides the anti-glare and anti-reflection film with high productivity.

The entire disclosure of each and every foreign patent application from which the benefit of foreign priority has been claimed in the present application is incorporated herein by reference, as if fully set forth.

What is claimed is:

1. An anti-glare and anti-reflection film comprising:
a transparent support;
an anti-glare layer; and
a low refractive index layer,
wherein a value of haze which is caused due to internal scattering of the anti-glare and anti-reflection film is 0 to 35%, and a center line average roughness Ra of the anti-glare and anti-reflection film is 0.08 to 0.30 μm.

2. The anti-glare and anti-reflection film of claim 1,
wherein the value of haze which is caused due to internal scattering of the anti-glare and anti-reflection film is 0 to 10%.

3. The anti-glare and anti-reflection film of claim 1,
wherein the value of haze which is caused due to surface scattering of the anti-glare and anti-reflection film is 5 to 15%.

4. The anti-glare and anti-reflection film of claim 3,
wherein the value of haze which is caused due to internal scattering of the anti-glare and anti-reflection film is 0 to 5%, and the value of haze which is caused due to surface scattering of the anti-glare and anti-reflection film is 5 to 10%.

5. The anti-glare and anti-reflection film of claim 1,
wherein the anti-glare layer comprises: at least one type of translucent microparticle having an average particle size of 0.5 to 10 μm; and a translucent resin, the translucent microparticle being are dispersed in the translucent resin,
an absolute value of a difference in refractive index between the translucent microparticle and the translucent resin is 0.00 to 0.03,
the translucent microparticle is contained in an amount of 3 to 30% by mass of a total solid content of the anti-glare layer, and
the low refractive index layer is formed by applying a coating composition and has a refractive index of 1.30 to 1.55.

6. The anti-glare and anti-reflection film of claim 5,
wherein the translucent resin is a polymer obtained from mainly a tri- or higher functional ionizing radiation curable compound.

7. The anti-glare and anti-reflection film of claim 6,
wherein the tri- or higher functional ionizing radiation curable compound mainly comprises a tri- or higher functional (meth)acrylate monomer, and the translucent microparticle is a crosslinkable poly(meth)acrylate polymer whose acryl content is 50 to 100% by mass.

8. The anti-glare and anti-reflection film of claim 6,
wherein the tri- or higher functional ionizing radiation curable compound mainly comprises a tri- or higher functional (meth)acrylate monomer, and
the translucent microparticle is a crosslinkable poly(styrene-acryl) copolymer whose acryl content is 50 to 100% by mass.

9. The anti-glare and anti-reflection film of claim 5,
wherein the low refractive index layer is formed by applying a curable composition mainly comprising a fluorinated polymer containing fluorine atoms in an amount of 35 to 80% by mass and a crosslinkable or polymerizable functional group.

10. The anti-glare and anti-reflection film of claim 9,
wherein the low refractive index layer is a cured film formed by applying and curing a curable composition comprising at least one of:
at least one type of (A) a fluorinated polymer;
at least one type of (B) an inorganic microparticle whose average particle size is 30% to 100% of a thickness of the low refractive index layer; and
at least one type of (C) at least one of a hydrolysate of organosilane and a partial condensate thereof, the organosilane being produced in the presence of an acid catalyst and represented by formula (1):
(R¹⁰)ₘSi(X)₄₋ₘ (1)
(where R¹⁰ denotes a substituted or unsubstituted alkyl group or a substituted or unsubstituted aryl group, X denotes a hydroxy group or a hydrolysable group, and m denotes an integer from 1 to 3).

11. The anti-glare and anti-reflection film of claim 10,
wherein each of the anti-glare layer and the low refractive index layer is a cured film formed by applying and curing a curable coating composition comprising at least one of the hydrolysate of organosilane represented by the formula (1) and the partial condensate thereof.

12. The antiglare, antireflection film of claim 10,
wherein said at least one of the hydrolysate of organosilane represented by the formula (1) and the partial condensate thereof is represented by formula (2): 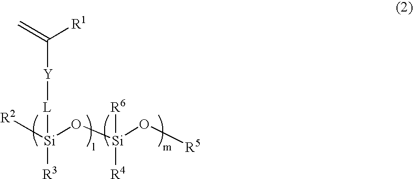
wherein, R¹ represents a hydrogen atom, methyl group, methoxy group, alkoxycarbonyl group, cyano group, fluorine atom or chlorine atom;
Y represents a single bond, *—COO—**, *—CONH—** or *—O—**;
L represents a di-valent connecting chain;
R² to R⁴ each independently represents a halogen atom, a hydroxy group, an unsubstituted alkoxy group or an unsubstituted alkyl group;
R⁵ represents a hydrogen atom or an unsubstituted alkyl group;
R⁶ represents a substituted or unsubstituted alkyl group or a substituted or unsubstituted aryl group; and
1 and m each represents a molar fraction (1 represents a numeral satisfying the numerical formula 1=100−m), and m represents a numeral of from 0 to 50.

13. The anti-glare and anti-reflection film of claim 10,
wherein the inorganic microparticle mainly comprises oxide silicon having a hollow structure and a refractive index of 1.17 to 1.40.

14. A polarizing plate comprising:
a polarizing film; and
two protection films bonded to the polarizing film, the protection films protecting both front and back surfaces of the polarizing film,
wherein the anti-reflection film of claim 1 is used as one of the protection films.

15. The polarizing plate of claim 14,
wherein one of the two protection films which is not used as the anti-glare and anti-reflection film is an optical compensation film having an optical compensation layer, the optical compensation layer comprising an optically anisotropic layer on a surface opposite to a surface which is bonded to the polarizing film,
the optically anisotropic layer comprises a compound having a discotic structural unit with a disk surface inclined with respect to the surface of the protection film at an angle which varies in a depth direction of the optically anisotropic layer.

16. A liquid crystal display device comprising at least one polarizing plate of claim 14.

17. The liquid crystal display device of claim 16,
wherein a diagonal of a display screen is 20 inches or more.

18. A method for producing the anti-glare and anti-reflection film of claim 1, the method comprising:
positioning a land of a tip lip of a slot die close to a surface of a continuously moving web of a transparent support which is supported by a backup roll; and
applying, from a slot of the tip lip, at least one of a coating composition for the anti-glare layer and a coating composition for the low refractive index layer on the transparent support, the coating composition for the anti-glare layer comprising a translucent microparticle, a translucent resin and a solvent, so as to provide at least one of the anti-glare layer and the low refractive index layer on the transparent support.
